(19) United States
(12) Patent Application Publication
(10) Pub. No.: US 2017/0154394 A1
(43) Pub. Date: Jun. 1, 2017

(54) Fatigue Optimized Routing & Tracking

(71) Applicant: Pulsar Informatics, Inc., Philadelphia, PA (US)

(72) Inventors: Kevin Gar Wah Kan, Philadelphia, PA (US); Christopher Grey Mott, Seattle, WA (US); Daniel Joseph Mollicone, Seattle, WA (US)

(73) Assignee: Pulsar Informatics, Inc., Philadelphia, PA (US)

(21) Appl. No.: 14/864,463

(22) Filed: Sep. 24, 2015

Related U.S. Application Data
(60) Provisional application No. 62/028,547, filed on Jul. 24, 2014.

(51) Int. Cl. G06Q 50/28; G06Q 10/06; G01C 21/34; G06Q 10/10

(52) U.S. Cl. CPC G06Q 50/28; G06Q 10/1097; G06Q 10/0635; G01C 21/3492; G01C 21/343; G01C 21/3461

(57) ABSTRACT

Systems and methods are provided in which optimized driving trip schedules are generated, optimized, optionally scored according to multiple criteria including fatigue, and provided to a driver or other personnel. Trip schedules are generated from route plans connecting start and end waypoints and optionally intermediate waypoints. Hours-of-service (HoS) regulations and business objectives (fuel efficiency, time-constrained waypoints, etc.) are considered, where a forward greedy algorithm may be used to solve the problem of on-time delivery under such constraints. Driver sleep and fatigue are then determined from the generated trip schedules using sleep prediction models and fatigue prediction models. Trip schedules may then be scored, modified, and optimized in accordance with several other constraints.

### RELATED APPLICATIONS

This application claims benefit of the priority of U.S. application No. 62/028,547 filed 24 Jul. 2014, which is incorporated herein in its entirety by reference.

### STATEMENT OF GOVERNMENT FUNDED RESEARCH

This invention was made with government support under contract No. DTRT57-12-C-10018 awarded by the U.S. Department of Transportation. The government may have certain rights in the invention.

### TECHNICAL FIELD

The presently disclosed invention relates generally to the optimization of driving routes for transportation enterprises such as trucking companies, and relates specifically to the optimization of driving routes in accordance with various optimization criteria including fatigue.

### BACKGROUND

Professional truck drivers are responsible for picking up and delivering loads in scenarios that may vary significantly by factors such as the location of the waypoints, the type of loads, pick-up and delivery time windows, driving conditions, and/or the like. In addition to meeting the pick-up and delivery requirements, drivers must comply with hours-of-service regulations that impose constraints on timing and duration of their work schedule based on mathematical formulas. Drivers seek cost-effectively to achieve their pick-up and delivery requirements, while maintaining compliance with hours-of-service regulations, and may wish to optimize other factors such as the reduction their fatigue while driving, or the selection of certain preferred routes. The combination of objectives and constraints presents a complex optimization problem for drivers for which it may be difficult to find optimal solutions.

Currently drivers may rely on pen-and-paper calculations to plan routes that are compliant with hours-of-service regulations. They may use rule of thumb approaches to estimate when to plan breaks or make stop-overs. Existing computerized route planning tools generate route maps between destinations, and may incorporate constraints on the start time or the arrival time, but do not address the full set of constraints imposed by hours-of-service rules, or other driver objectives. There has therefore been a long-felt need for the capability of creating fatigue-optimized route creation and vehicle tracking.

### SUMMARY

Among its many aims and objectives, the presently disclosed invention comprises one or more route planning algorithms that generate a trip schedule for a driver that will optimize for compliance with hours-of-service requirements, waypoint requirements, and other driving factors such as fatigue, driving conditions, delivery efficiency, fuel economy, other economic factors, and/or the like. According to particular embodiments, the provided trip schedule may include recommendations for waypoint locations, road segments, times at which to drive or go off-duty, and may include reports about risks such as fatigue level or driving conditions.

Particular embodiments of the presently disclosed invention provide a method, using a processor, for providing a driver with a fatigue-risk optimized driving trip schedule, the method comprising: receiving, at the processor, trip data comprising at least in part a start waypoint, a start time interval, an end waypoint, and an end time interval, the start and end waypoints each comprising at least a geographic location; receiving, at the processor, one or more driver hours-of-service rules, wherein the driver hours-of-service rules represent one or more constraints on a schedule of driving activities; receiving, at the processor, a sleep prediction model, the sleep prediction model comprised to determine a sleep schedule for a driver based at least in part upon a schedule of driving activities; receiving, at the processor, a fatigue prediction model, the fatigue prediction model comprised to determine one or more fatigue levels associated with a driver based at least in part upon a sleep schedule for the driver; generating, with the processor, one or more route plans based at least in part on the received trip data, each route plan comprising one or more route segments, each route segment comprising at least in part a route segment start location and a route segment end location, wherein the one or more route segments comprise a path, at least, connecting the start waypoint to the end waypoint; generating, with the processor, one or more trip schedules for each generated route plan, each trip schedule comprising at least in part one or more driving segments, each driving segment corresponding to a driving activity and comprising a driving segment start time and a driving segment end time, and wherein generating the trip schedule comprises, at least in part: creating a driving segment corresponding to each route segment in a generated route plan, and estimating the driving segment start time and the driving segment end time for each driving segment; determining, with the processor, one or more driver sleep schedules by applying the received sleep prediction model, at least in part, to the schedule of driving activities specified in a generated trip schedule; determining, with the processor, one or more fatigue levels associated with at least one generated trip schedule, wherein the fatigue levels are based upon applying the received fatigue prediction model to at least one of the one or more determined sleep schedules determined from the at least one generated trip schedule; and providing at least one determined trip schedule and at least one determined fatigue level to one or more of: a driver, an administrative user, a business manager, and a government regulator.

### BRIEF DESCRIPTION OF THE DRAWINGS

In drawings that depict non-limiting embodiments of the invention:

The multiple views of FIG. 1 provide flowchart diagrams illustrating various method steps of the invention, specifically in which:

FIG. 1A provides a flowchart diagram illustrating a method 100 for providing a driver with a fatigue-risk optimized driving trip schedule, in accordance with particular embodiments;

FIG. 1B provides a flowchart diagram illustrating a method 150 for generating a route plan, in accordance with particular embodiments; and

FIG. 1C provides a flowchart diagram illustrating a method 120 for updating a selected driving trip with real-time information, in accordance with particular embodiments; The multiple views of FIG. 2 provide data class diagrams for various data types used in accordance with particular embodiments, specifically in which:

FIG. 2A provides a data class diagram for trip data, in accordance with particular embodiments;

FIG. 2B provides a data class diagram for waypoint data, in accordance with particular embodiments;

FIG. 2C provides a data class diagram for a simple version of a route plan (for routes to trips with no intermediate waypoints), in accordance with particular embodiments;

FIG. 2D provides a data class diagram for an arbitrary version of a route plan (for routes to trips with an arbitrary number, N, of intermediate waypoints), in accordance with particular embodiments;

FIG. 2E provides a data class diagram for driving segment data, in accordance with particular embodiments; and

FIG. 2F provides a data class diagram for a trip schedule, in accordance with particular embodiments;

The multiple views of FIG. 3 illustrate the analysis of an exemplary driving trip into various routes, according to particular embodiments, specifically in which:

FIGS. 3A, 3B, and 3C each illustrate different routes for a trip defined by the same starting and ending waypoints, according to particular embodiments;

FIG. 4 illustrates a route plan that has been selected or “optimized” in accordance with the foregoing methods of the presently disclosed invention, in accordance with particular embodiments;

FIG. 5 comprises a plot illustrating the variation of the homeostatic process of a typical subject over the transitions between being asleep and awake, in accordance with particular embodiments;

The multiple views of FIG. 6 (FIGS. 6A through 6P) illustrate various stages of the trip scheduling algorithm to determine a feasible schedule given hours-schedule constraints on driving activities, in accordance with particular embodiments;

FIG. 7 illustrates operation of the optimization algorithm for a multiple number of iterations, in accordance with particular embodiments;

FIG. 8 provides a graph of fatigue score for a give trip (y-axis) versus the number of iterations of the optimization algorithm, in accordance with particular embodiments;

FIG. 9 provides a driver schedule determined from an optimized trip schedule; in accordance with particular embodiments; and

The multiple views of FIG. 10 provide graphs illustrating a driver fatigue level during one or more driving trips, specifically in which:

FIG. 10A provides multiple graphs illustrating the iterative application of sleep prediction model to generate the sleep-wake schedule for a work schedule with no work shifts during the duration of the provided work schedule; and

FIG. 10B provides multiple graphs illustrating the iterative application of sleep prediction model to generate the sleep-wake schedule for a work schedule with several work shifts during the duration of the provided work schedule; and

FIG. 11 provides a graph illustrating the prediction of a fatigue level of a driver over time, in accordance with particular embodiments.

### DETAILED DESCRIPTION

Throughout the following discussion, specific details are set forth in order to provide a more thorough understanding of the disclosed invention. The invention, however, may be practiced without these particulars. In other instances, well-known elements have not been shown or described in detail to avoid unnecessarily obscuring the invention. Accordingly, the specification and drawings are to be regarded in an illustrative rather than a restrictive sense.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein. As used herein, the term processor means one or more processors, and one or more particular processors, such as a motion detection processor and a motion tracking processor, can be embodied on one or more processors.

One or more figures show block diagrams of systems and apparatus of embodiments of the invention. One or more figures show flow diagrams illustrating systems and apparatus for such embodiments. The operations of the one or more flow diagrams will be described with references to the systems/apparatuses shown in the one or more block diagrams. However, it should be understood that the operations of the one or more flow diagrams could be performed by embodiments of systems and apparatus other than those discussed with reference to the one or more block diagrams, and embodiments discussed with reference to the systems/apparatus could perform operations different than those discussed with reference to the one or more flow diagrams.

The following discussion and the appended claims use particular terminology in precise ways that may not reflect the common vernacular or usage among ordinary artisans. Specifically, as used herein and in the appended claims, the term “driving trip” or simply “trip” (meant to be synonymous) refers to a plurality of locations (called “waypoints”) comprising at least a start waypoint and an end waypoint, and one or more optional intermediate waypoints. Each waypoint defines a mandatory location to be included within the driving trip. Naturally, a trip must have a beginning and an end location, referred to herein and in the appended claims as the “start waypoint” and the “end waypoint,” respectively. Intermediate waypoints are additional points of interest (e.g., truck stops, client locations, service centers, etc.) that may from time to time be required stops on any given trip. In particular embodiments, the optional intermediate waypoints are also accompanied with a defined order (e.g., a “first” intermediate waypoint, a “second” intermediate waypoint, etc.). In other embodiments, the order of waypoints may not be strictly defined or may have some degree of variability. The terms “driving trip” and “trip,” however, are construed so as to incorporate any defined, undefined, or partially defined order among the optional intermediate waypoints.

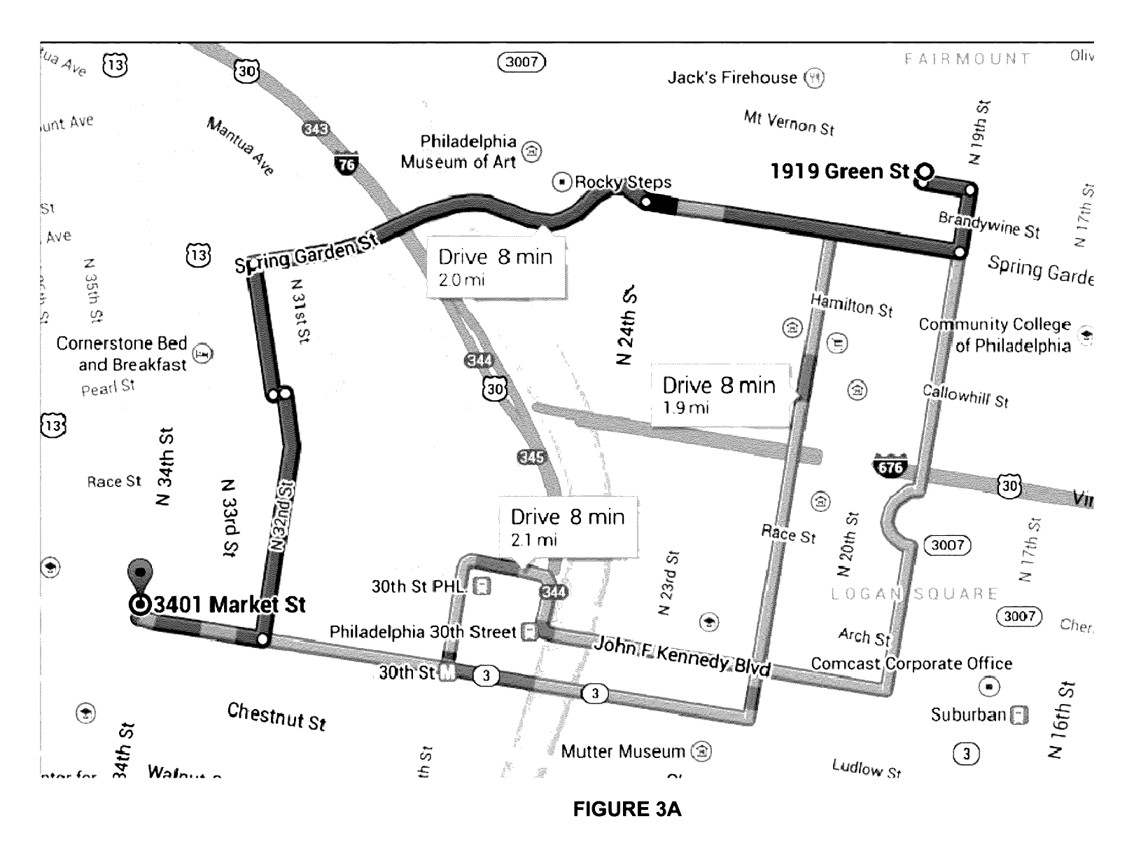

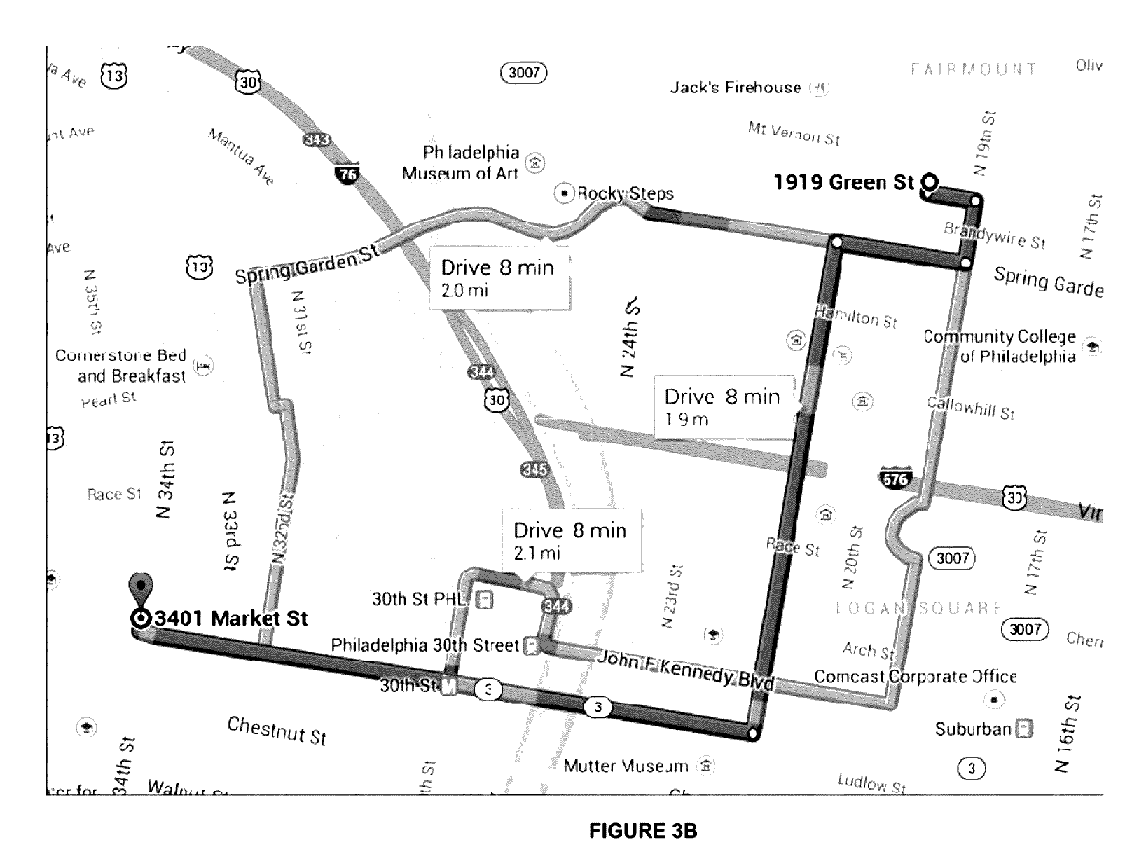

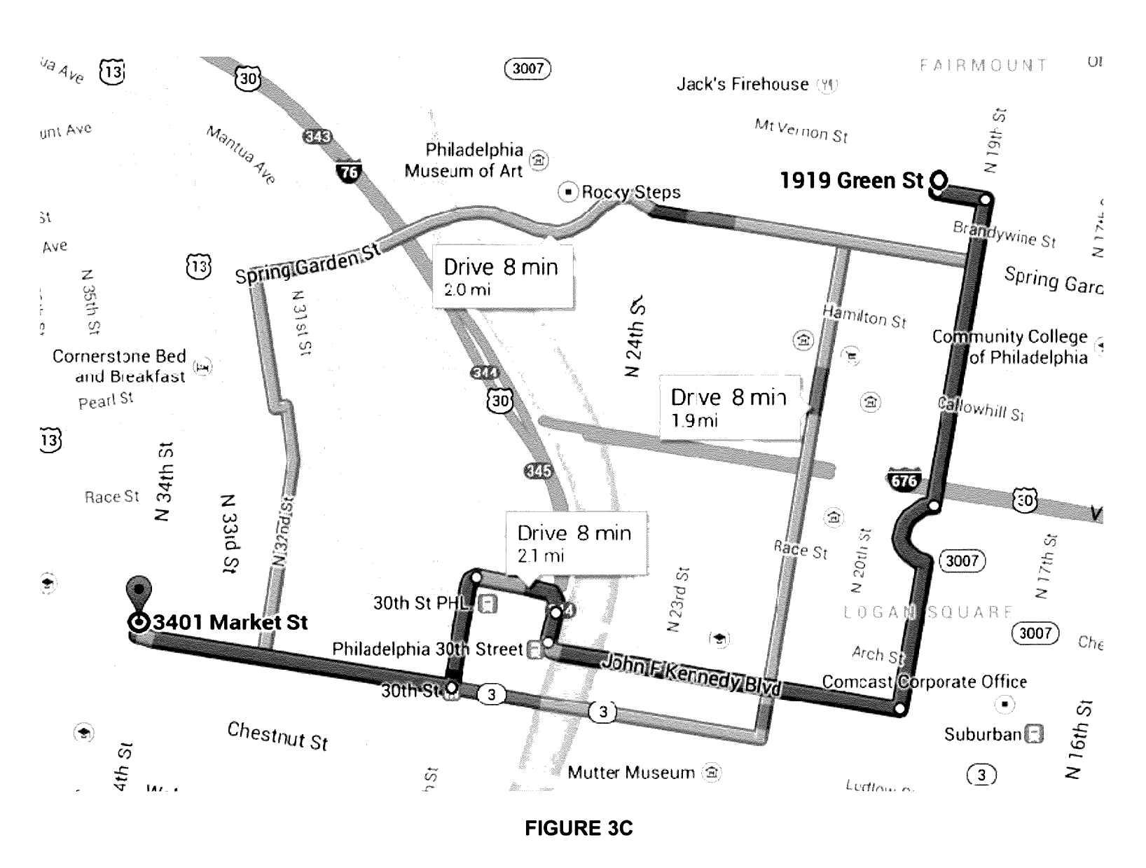

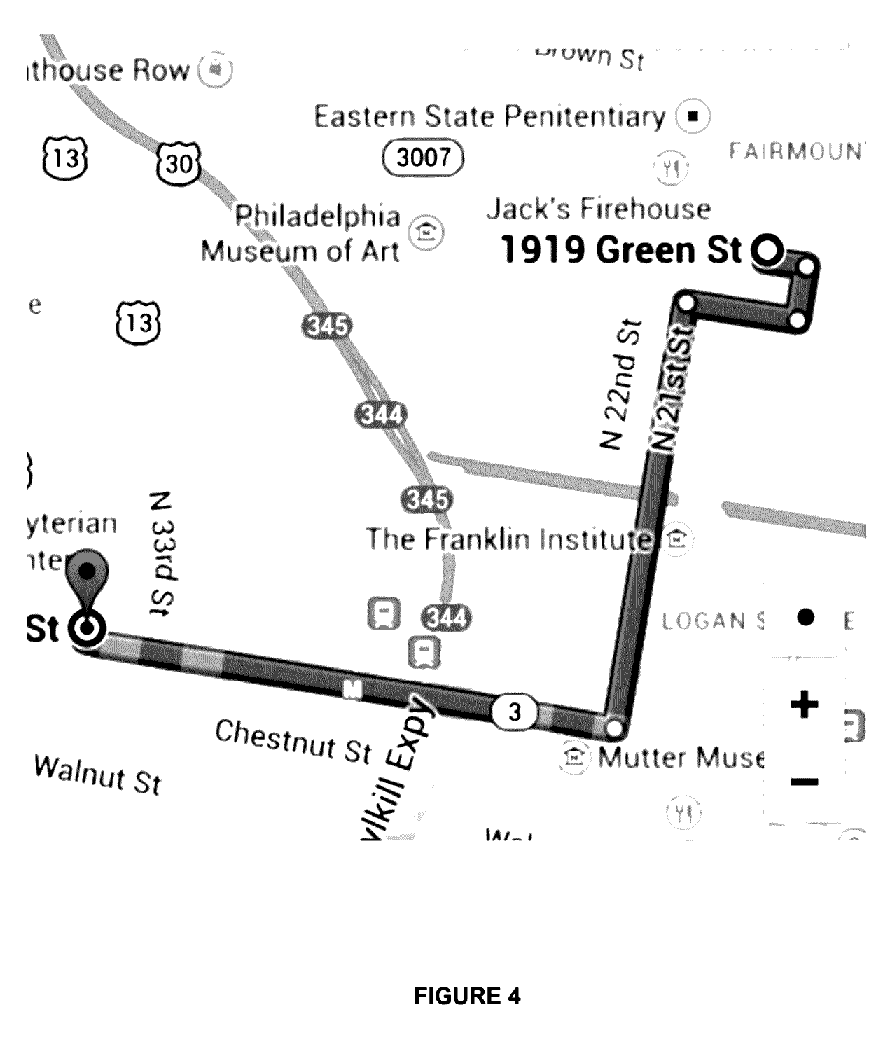

As used herein and in the appended claims, the term “route plan” refers to a specific path to be taken to connect the waypoints of a driving trip in the required order. Unlike a driving trip a route plan will define specific streets, roads, highways and/or the like to take in order to travel from the start waypoint to the end waypoint of a trip and, if specified, to intersect each of the optional intermediate waypoints in the specified order (if any). It should be appreciated that a specific driving trip may give rise to more than one route plan, since seldom is there a single path to travel from one location to another. The multiple views of FIG. 3, for example, illustrate three (3) routes for a trip defined between two waypoints.

As used herein and in the appended claims, the term “route segment” refers to a specific street, road, highway, freeway, interstate highway, exit, artery, avenue, boulevard, beltway, parkway, byway, bypass, side street, alleyway, crossroad, any other specific carriageway by which a vehicle may travel during the driving of a route, and/or the like. A route typically comprises a plurality of segments (but, without limitation, in some embodiments a route may comprise only one segment). Segments also can often (without limitation) be identified by name—e.g., Highway 202 between exits 36 and 38, Main Street between 1^{st} and 4^{th} Avenues, and/or the like. A segment may comprise at least in part a segment start location and a segment end location, collectively referred to herein, and in the appended claims, as “nodes.” An ordered string of segments are pieced together to form a route by use of the nodes, inasmuch as the segment end location of one segment becomes the segment start location of the following segment. The “nodes” terminology is useful when needing to refer to such locations irrespective of having to specify to which segment the node corresponds.

As used herein in and in the appended claims, the term “driving segment” refers to the combination of a route segment and a specific time that route segment is driven—e.g., driving Highway 202 between exits 36 and 38, starting at 3:15 PM and ending at 3:25 PM. Driving segments may be generated by providing specific times to the driving activities needed to traverse route segments.

As used herein and in the appended claims, the term “trip schedule” refers to a specified schedule (which, according to particular embodiments, may have some degree of variability within it) by which to drive a given route. Route plans are time independent; trip schedules are not. A trip schedule may include a departure time (or departure time interval) and/or an arrival time (or arrival time interval) for one or more (including potentially all) of the waypoints and one or more (including potentially all) of the nodes. The trip schedule may also include an estimated time of travel for one or more (including potentially all) of the segments. It should be appreciated that the same route may give rise to different trip schedule depending upon a number of factors, including (without limitation) the time of day the route starts (since traffic patterns and travel times may vary by time of day), variability in the duration of any planned stops at one or more waypoints or nodes, changes in weather patterns, seasonal fluctuations in traffic flow, and/or the like.

Further, as used herein and in the appended claims, the term “driving schedule” refers to the time or time blocks that a driver is operating a vehicle or otherwise engaged in work (e.g., loading, unloading, servicing, etc.) irrespective of where the driving or work takes place. Driving schedules exist independently of any given trip, route, segment, or plan—although a route plan and a driving schedule may be combined to create a trip schedule, according to particular embodiments.

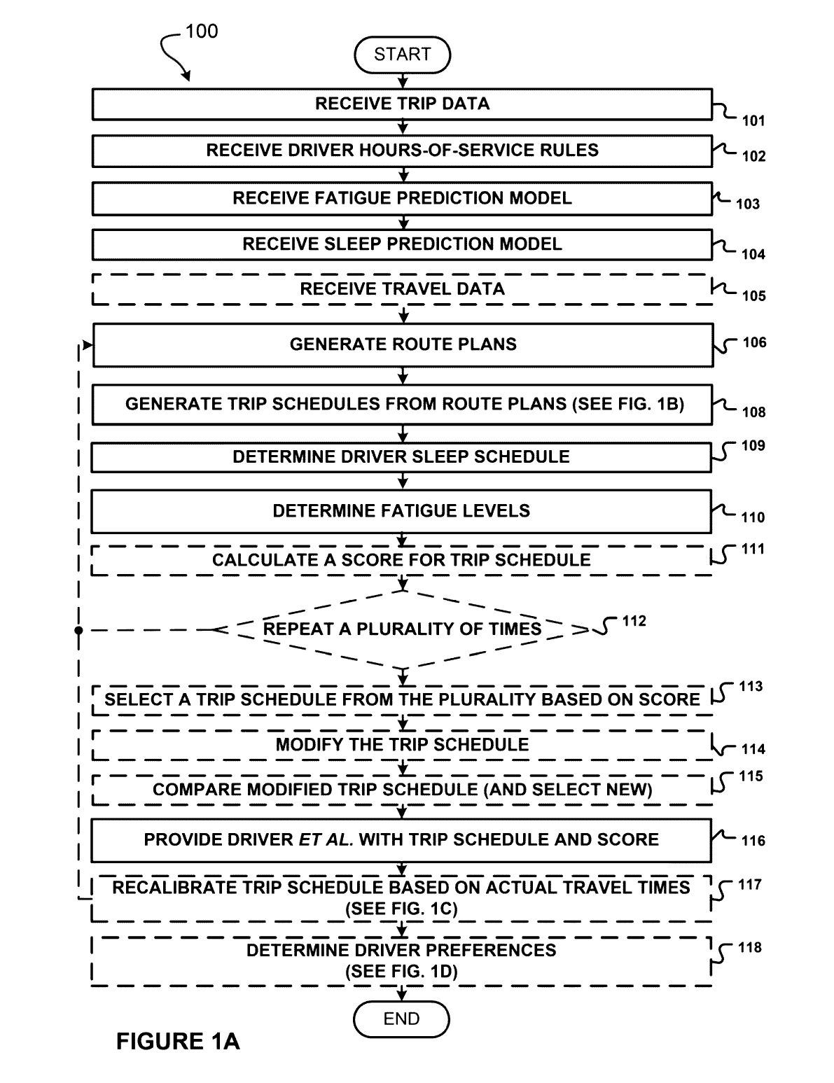

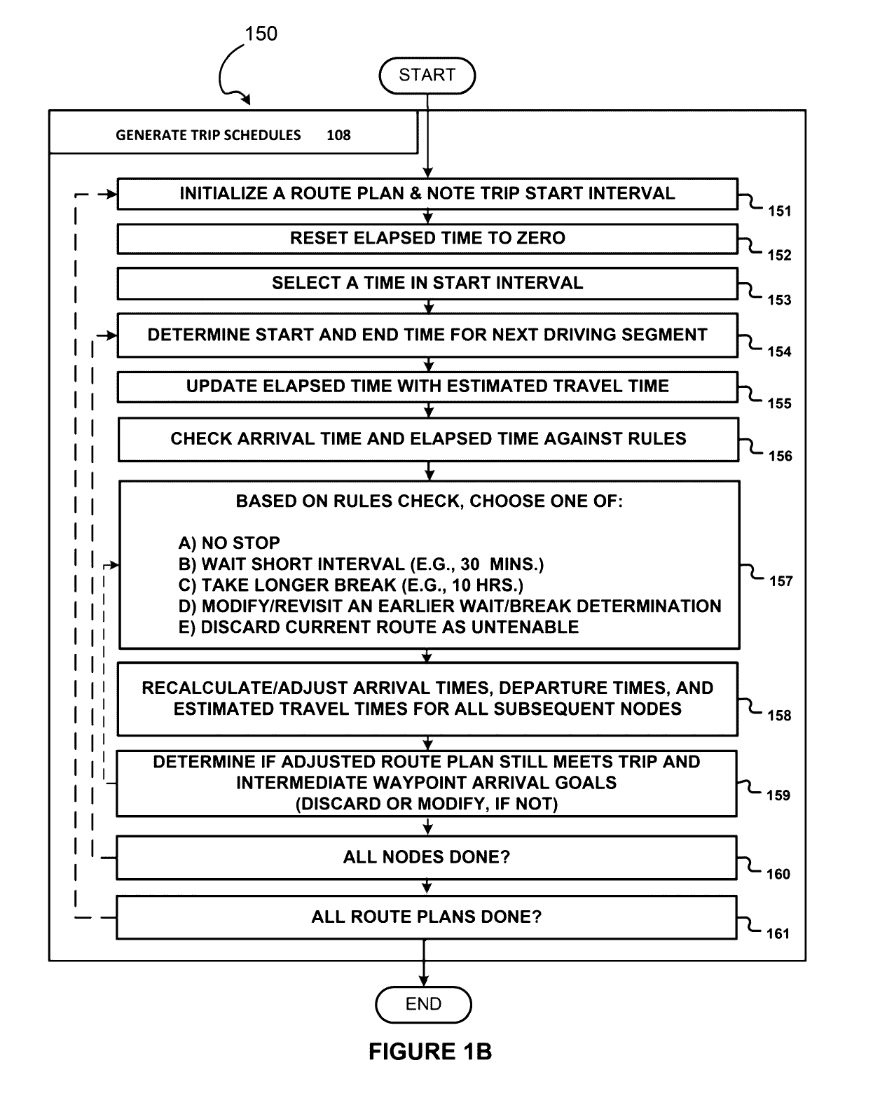

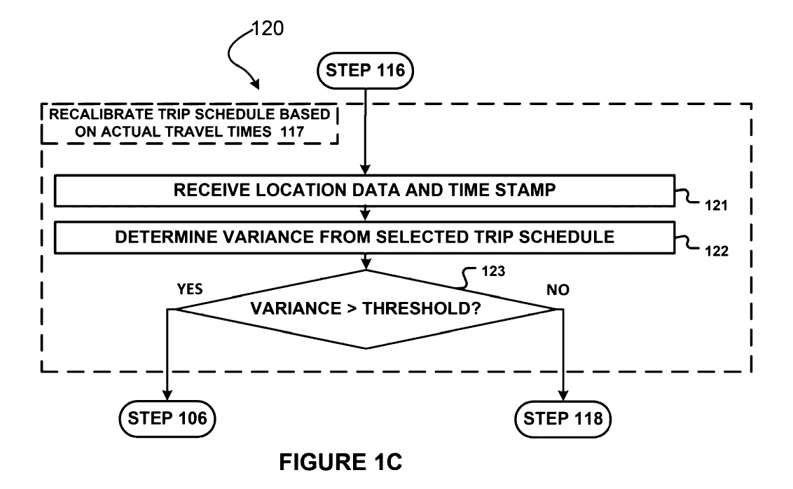

The multiple views of FIG. 1 provide various flowchart diagrams for describing various processes used in particular embodiments. The steps shown are to be taken in their general sense and may be performed in any order, performed repeated, omitted as needed, and otherwise be read in the spirt of describing the presently disclosed invention, not limiting it to the figures themselves. In particular embodiments, each enumerated and identified step is to be considered a logical, separate process unit. In other embodiments, the steps may be considered logically and/or temporally interchangeable and may be incorporated into one another, performed separately or jointly, performed in series or in parallel with one another, or performed in a strict ordered sequence or in a varied sequence including repeating some steps but possibly not others. The diagrams provided within the multiple views of FIG. 1 are therefore to be taken in their most general sense, without any unnecessary limitations implied therein.

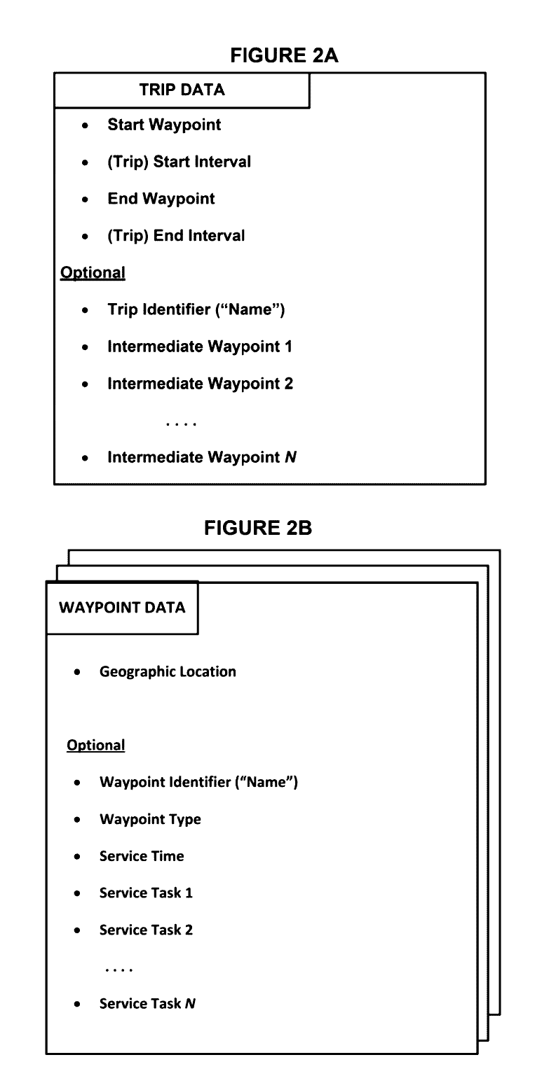

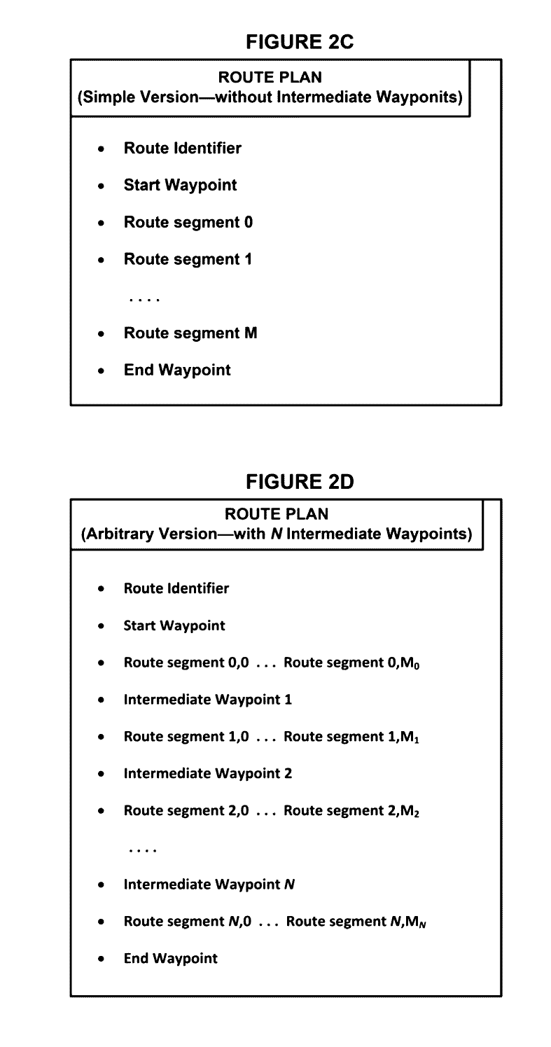

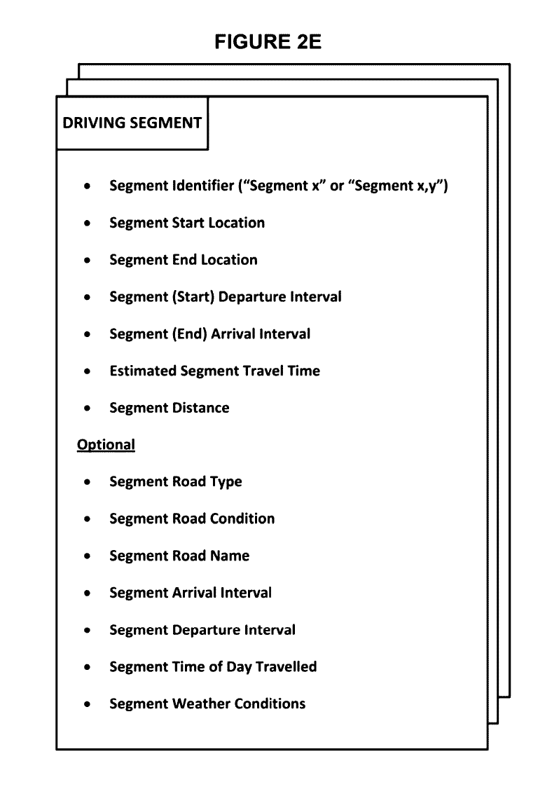

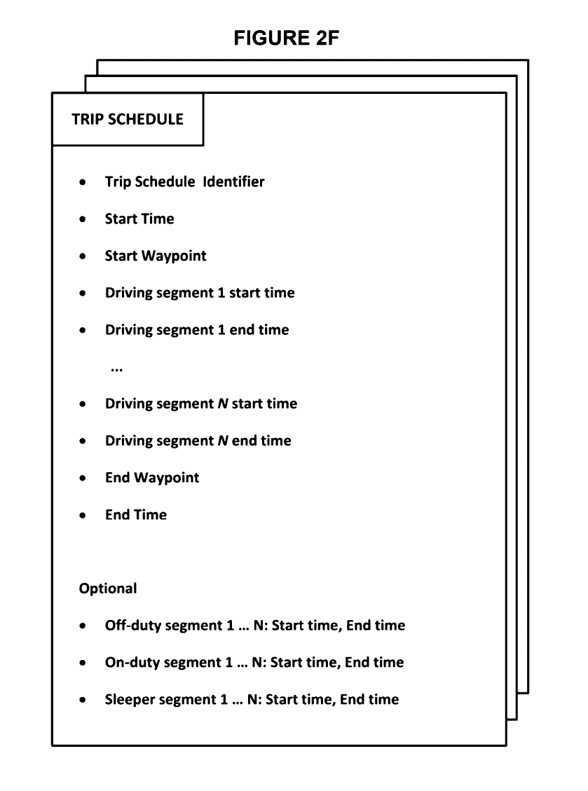

FIG. 1A provides a flowchart illustrating a method 100 for providing an optimized trip schedule to a driver of a vehicle in accordance with particular embodiments. Method 100 commences in step 101 wherein trip data is received at a computer or processor. Trip data, as illustrated in (non-limiting) exemplary data class diagram of FIG. 2A, comprises at least in part a start waypoint, an end waypoint, a start time interval, and an end time interval. The start and end waypoints identify a location where the trip is to start and to stop, respectively, and the start and end intervals identify one or more times during which the trip is to commence and to terminate, respectively. Waypoints may be identified by name, by map identifiers (map coordinates, street names, intersection names, etc.), by geographic coordinates (e.g., longitude and latitude, etc.) and/or the like. Trip data may also comprise one or more optional intermediate waypoints, according to particular embodiments. Trip data may also comprise, according to particular embodiments, a trip name or identifier and any other information that would assist managers to track and to analyze operational performance on a given trip.

Waypoints—whether start waypoints, end waypoints, or any of the one or more optional intermediate waypoints—share similar features when encapsulated into received trip data of step 101. Specifically, waypoint data, as illustrated in (non-limiting) exemplary data class diagram of FIG. 2B, comprises at least in part a waypoint location, a waypoint arrival interval, and a waypoint departure interval. Waypoint data may also comprise, according to particular embodiments, a waypoint identifier (or name), a waypoint type (e.g., service station, client location, weigh station, rest stop, etc.), a service time (e.g., a time needed at the waypoint to perform one or more service tasks), and one or more service tasks to be performed at the waypoint (e.g., loading, unloading, weighing, servicing, etc.).

Method 100 may continue to step 102 wherein one or more hours-of-service rules are received at the processor, in accordance with particular embodiments. The legal and/or regulatory framework used in the illustrative method 100 comprises a set of five rules set by the Federal Motor Carrier Safety Administration, a division of the U.S. Department of Transportation, and specifically geared for trucking routes involving one driver driving a single-unit carrier (i.e., not a “double” long load). These specific rules are not limiting, however, and any legal, regulatory, economic, or business-oriented restrictions on driving activity may be utilized by alternative embodiments of the invention. For purely exemplary purposes, it will be assumed that the only rules by applicable regulations are spelled out in Table 1, below.

TABLE 1
Exemplary Hours-of-service Rules

| | |
|---|---|
| 1. | The driver must take a 30 min. break during |
| | the first 8 hours of work on any shift. |
| 2. | The driver must take a 30 min. break during |
| | the first 8 hours of work on any shift. |
| 3. | The maximum work day (including driving and |
| | non-driving work activities, such as loading, |
| | unloading, servicing, etc.) is 14 hours. |
| 4. | The maximum work week (including driving and |
| | non-driving work activities) is 70 hours |
| | (subject to Rule 5, below). |
| 5. | The 70 hour maximum work week can be exceeded |
| | only if it includes a 34 hour consecutive break |
| | that must span two periods comprising the time |
| | between 1 AM and 5 AM in the driver's local |
| | time zone. |

These rules (a simplified version of the “HOS” or “Hours-of-service” rules) can be used as a default legal and/or regulatory framework by the presently disclosed system, can be hardwired or hard coded into the presently disclosed invention, or may optionally be provided (as could any legal and/or regulatory framework) in accordance with step 102 (receive HOS rules) of method 100, according to differing sets of embodiments, respectively. Instructions and/or data expressing such regulations may be received at the processor in any fashion as known in the art, including without limitation encoded rules, hash tables, look-up tables, Boolean operations, computer code, and/or the like. In particular embodiments, Step-102 received hours-of-service rules may also specify one or more other parameters relevant to the specific selection or application of one or more legal or regulatory frameworks—for example (without limitation) the time during which the framework is to be applied; the vehicles, drivers, number of drivers, routes, segments, waypoints etc. to which the framework is to be applied; and/or the like.

Method 100 may continue to step 103 wherein a fatigue prediction model is received at the processor, in accordance with particular embodiments. The presently disclosed invention is designed to utilize any biomathematical model designed generally to model any one or more of a human subject's neurobehavioral performance characteristics including fatigue. Such biomathematical models are referred to herein as “fatigue prediction models,” although they may model neurobehavioral characteristics other than just fatigue. Particular embodiments, however, are specifically designed to utilize biomathematical models that model a human subject's alertness and/or fatigue state. Such biomathematical models are referred to herein as “fatigue prediction models” or simply “fatigue models” (used synonymously).

Among the step-103 received fatigue prediction models utilized by the presently disclosed invention, particular embodiments may utilize the so-called “two-process model” of sleep regulation developed by Borbèly et al. in 1999. The Borbèly two-process model posits the existence of two primary regulatory mechanisms: (i) a sleep/wake-related mechanism that builds up exponentially during the time that the subject is awake and declines exponentially during the time that the subject is asleep, and is called the “homeostatic process” or “process S;” and (ii) an oscillatory mechanism with a period of (nearly) 24 hours, called the “circadian process” or “process C.” Without wishing to be bound by theory, the circadian process has been demonstrated to be orchestrated by the suprachiasmatic nuclei of the hypothalamus. The neurobiology of the homeostatic process is only partially known and may involve multiple neuroanatomical structures. Total alertness at a given time y(t), which is one non-limiting example of neurobehavioral performance, may then be represented as a sum of the C and S processes (see Equation 3, below).

Further details of the Borbèly two-process fatigue model are contained in PCT published patent application Systems and Methods for Individualized Alertness Predictions, inventors Mott C. G., Mollicone, D. J., et al., WIPO publication No. WO 2009/052633, the entirety of which is incorporated herein by reference and from which portions of the following discussion are excerpted for convenience and clarity.

Specifically, in accordance with the two-process model, the circadian process C may be represented by:

$$C ( t ) = γ {\sum }_{l = 1}^{5} {a}_{l} sin ( 2 l π ( t - ϕ ) / τ ) \qquad ( 1 )$$

where t denotes clock time (in hours, e.g. relative to midnight), φ represents the circadian phase offset (i.e. the timing of the circadian process C relative to clock time), γ represents the circadian amplitude, and τ represents the circadian period which may be fixed at a value of approximately or exactly 24 hours. The summation over the index l serves to allow for harmonics in the sinusoidal shape of the circadian process. For one particular application of the two-process model for alertness prediction, l has been taken to vary from 1 to 5, with constants a₁ being fixed at a₁==0.97, a₂=0.22, a₃=0.07, a₄=0.03, and a₅=0.001.

The homeostatic process S may be represented by:

$$S ( t ) = \{ \begin{matrix}{e}^{- {ρ}_{w} Δ t} {S}_{t - Δ t} + ( 1 - {e}^{- {ρ}_{w} Δ t} ) & if during wakefulness ( 2 a ) \\ {e}^{- {ρ}_{w} Δ t} {S}_{t - Δ t} & if during sleep ( 2 b )\end{matrix}$$

(S>0), where t denotes (cumulative) clock time, Δt represents the duration of time step from a previously calculated value of S. ρ_{w} represents the time constant for the build-up of the homeostatic process during wakefulness, and ρₛ represents the time constant for the recovery of the homeostatic process during sleep.

Given equations (1), (2a) and (2b), the total alertness according to the two-process model may be expressed as a sum of: the circadian process C, the homeostatic process S multiplied by a scaling factor κ, and an added noise component ε(t):

y(t)=κS(t)+C(t)+ε(t) (3)

Furthermore, it is useful to be able to describe the homeostatic process S for test subject after one or more transitions between being asleep and being awake. The sleep-wake transitions are commonly (but without limitation) represented as square wave signals oscillating between the binary states of being asleep (value=1 herein, without limitation) and being awake (value=0 herein, without limitation), referred to as sleep functions.

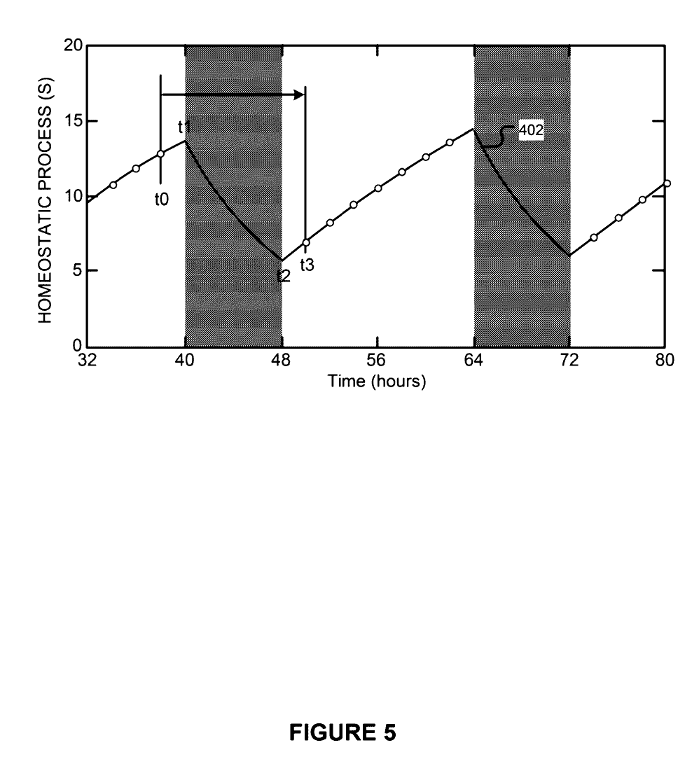

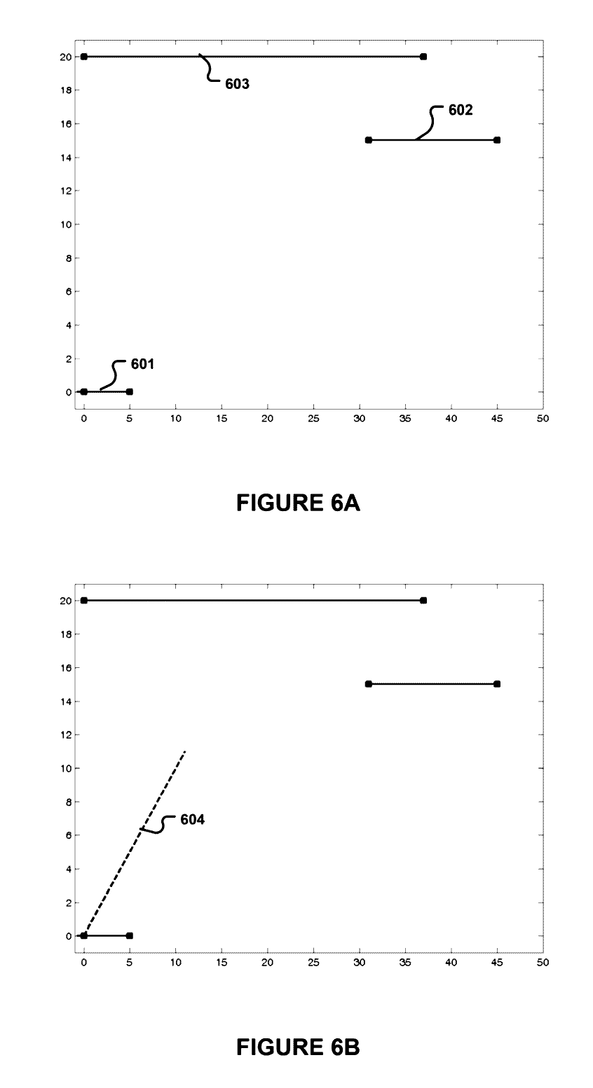

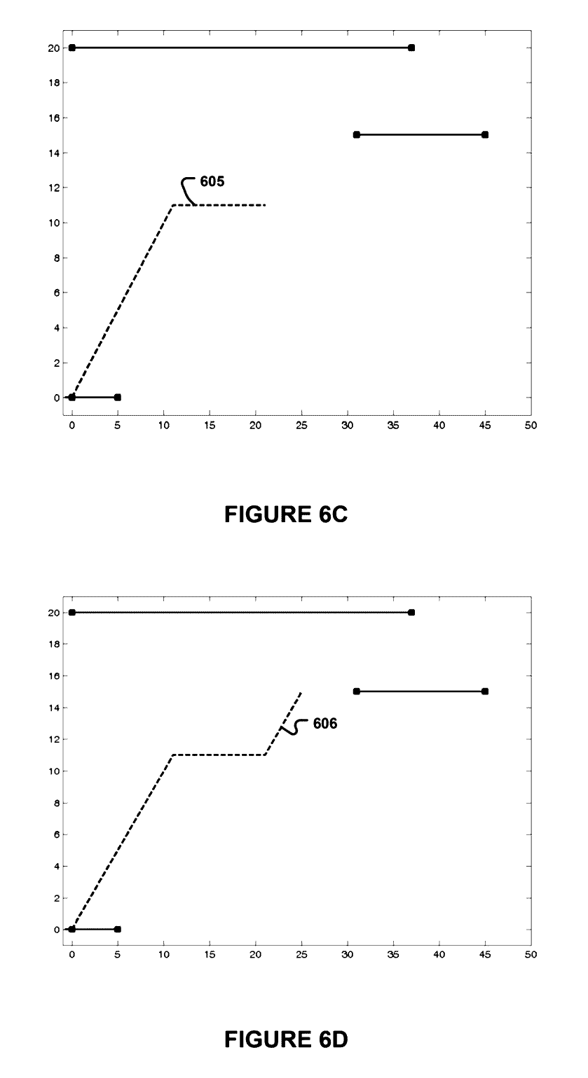

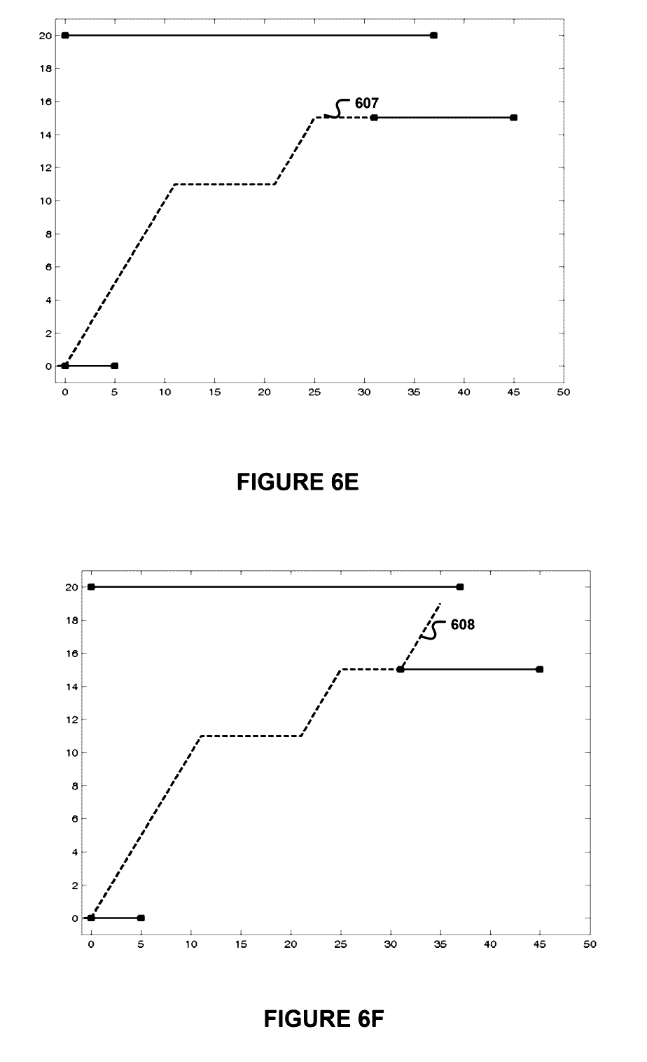

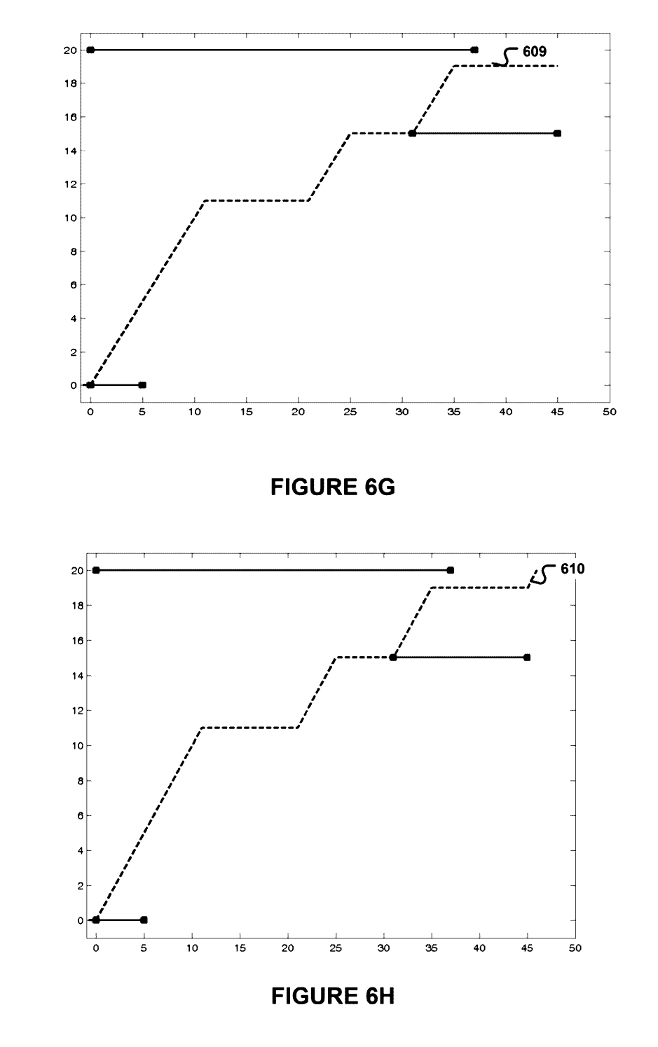

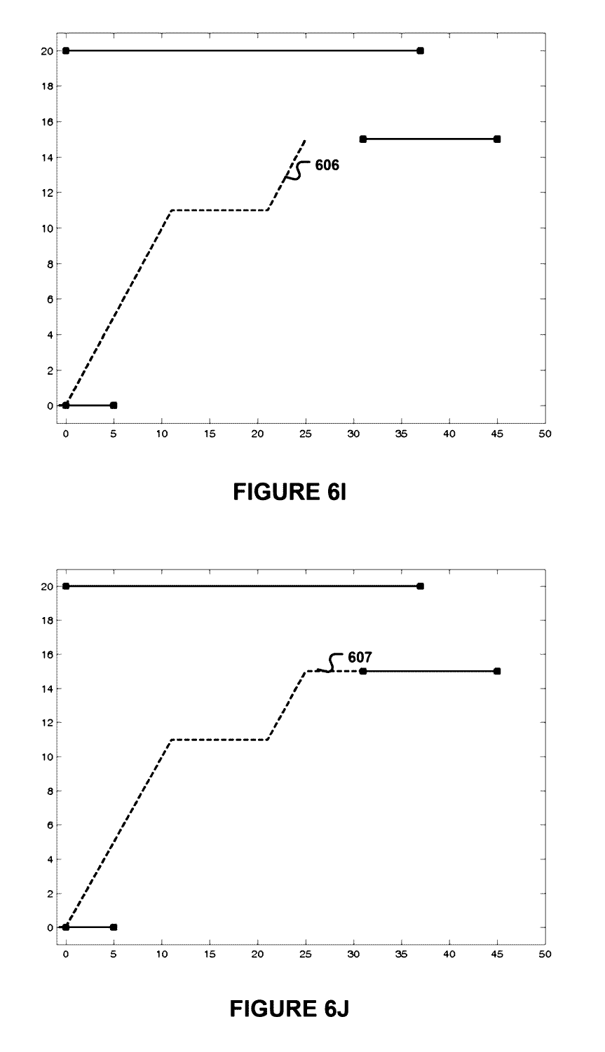

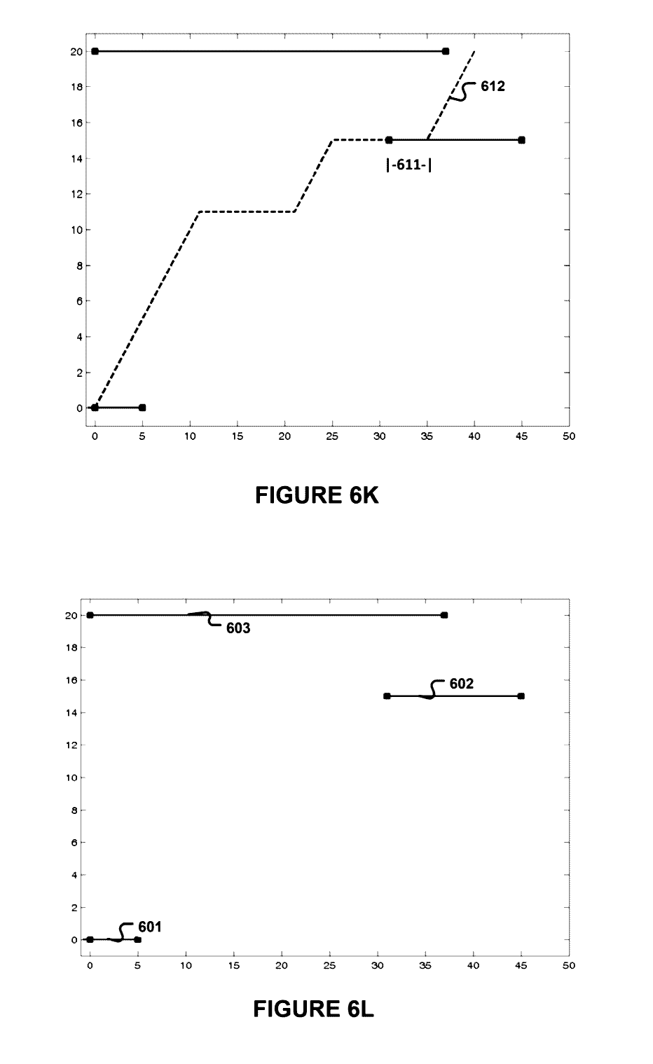

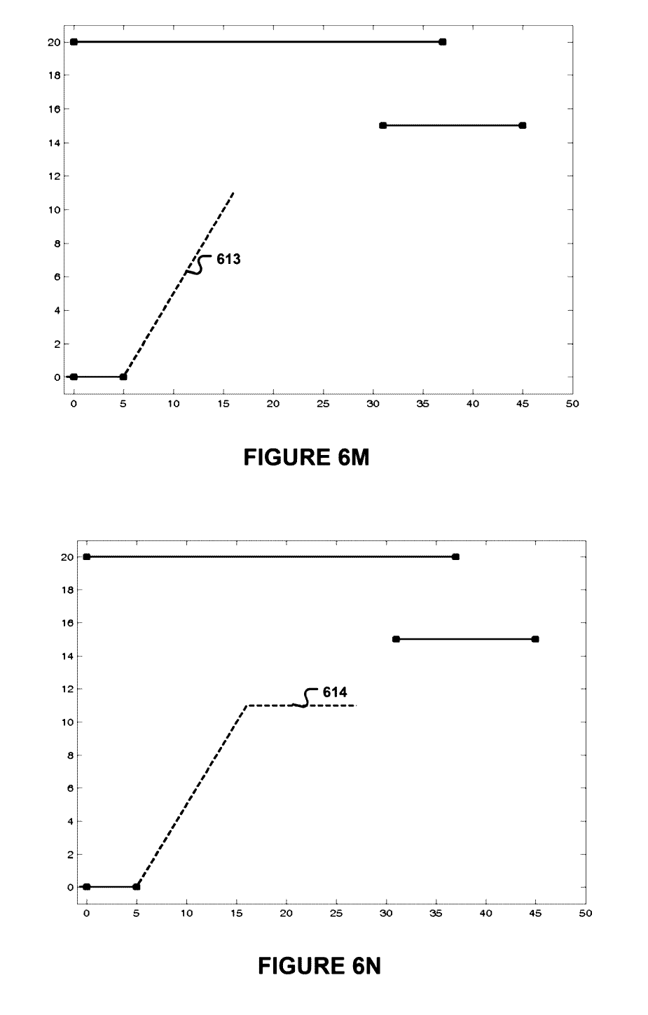

As described in more particular detail below, the systems and methods of the invention may make use of measured neurobehavioral performance levels which is typically only available when the subject is awake. Consequently, it may be desirable to describe the homeostatic process between successive periods that the test subject is awake. As the circadian process C is independent from the homeostatic process S, we may consider as an illustrative case of neurobehavioral performance using only the homeostatic process S of equations (2a), (2b). Consider the period between t₀ and t₃ shown in FIG. 5. During this period, the subject undergoes a transition from awake to asleep at time t₁ and a transition from asleep to awake at time t₂. Applying the homeostatic equations (2a), (2b) to the individual segments of the period between to and t₃ yields:

S(t₁)=S(t₀)e^{-ρ}^{_{w}}^{T}^{₁}+(1−e^{-ρ}^{_{w}}^{T}^{₁}) (4a)

S(t₂)=S(t₁)e^{-ρ}^{ₓ}^{T}^{₂} (4b)

S(t₃)=S(t₂)e^{-ρ}^{ₓ}^{T}^{₃}+(1−e^{-ρ}^{ₓ}^{T}^{₃}) (4c)

where

T₁=t₁−t₀ (5a)

T₂=t₂−t₁ (5b)

T₃=t₃−t₂ (5c)

Substituting equation (5a) into (5b) and then (5b) into (5c) yields an equation for the homeostat at a time t₃ as a function of an initial known homeostat condition S(t₀), the time constants of the homeostatic equations (ρ_{w}, ρₛ) and the transition durations (T₁, T₂, T₃):

$$\begin{matrix}S ( {t}_{3} ) = fs ( S ( {t}_{0} ) , {ρ}_{w} , {ρ}_{s} , {T}_{1} , {T}_{2} , {T}_{3} ) \\ = [ S ( {t}_{0} ) {e}^{- {ρ}_{w} {T}_{1}} + ( 1 - {e}^{- {ρ}_{w} {T}_{1}} ) ] {e}^{- ρ , {T}_{2} - {ρ}_{w} {T}_{3}} + \\ ( 1 - {e}^{- {ρ}_{w} {T}_{3}} )\end{matrix} \qquad ( 6 )$$

Equation (6) applies to the circumstance where to occurs during a period when the test subject is awake, there is a single transition between awake and asleep at t₁ (where t₀<t₁<t₃), there is a single transition between asleep and awake at t₂ (where t₁<t₂<t₃), and then t₃ occurs after the test subject is awake again.

Additional fatigue models may be utilized by particular embodiments. Other non-limiting examples of fatigue models include Akerstedt's “three-process model of alertness” (see, e.g., Akerstadt, T., et al. “Predictions from the Three-Process Model of Alertness,” Aviation, Space, and Environmental Medicine, 75:No. 3, §II (March 2004); see also Akerstedt, T. et al. “A Model of Human Sleepiness,” excerpted from Sleep '90 J. Home, Ed. (Pontenagel Press 1990)); Achermann's “two-process model revisited” (see e.g., Achermann, P., “The Two-Process Model of Sleep Regulation Revisited,” Aviation, Space, and Environmental Medicine, 75:No. 3, §II (March 2004)); Avinash's “process-U model” (see Avinash, D., “Parameter Estimation for a Biomathematical Model of Psychomotor Vigilance Performance under Laboratory Conditions of Chronic Sleep,” Sleep-Wake Research in the Netherlands 16:39-42 (Dutch Society for Sleep-Wake Research 2005); Beersma's “modified two-process model” (see, e.g., Beersma, D. G. M., “Models of Human Sleep Regulation,” Sleep Medicine Reviews 2:No. 1, pp. 31-43 (W.B. Saunders Co. Ltd. 1998)); Belyavin and Spencer's “QinetiQ Approach” (see, e.g., Belyavin, A. J. and Spencer, M. B., “Modeling Performance and Alertness: the QinetiQ Approach,” Aviation, Space, and Environmental Medicine, 75:No. 3, §II (March 2004)); the “circadian alertness simulator” (see, e.g., Dijk, D. J., et al. “Fatigue and Performance Models: General Background and Commentary on the Circadian Alertness Simulator for Fatigue Risk Assessment in Transportation,” Aviation, Space, and Environmental Medicine, 75:No. 3, §II (March 2004)); the so-called “new model class” (see, e.g., McCauley, P., et al, “A new mathematical model for the homeostatic effects of sleep loss on neurobehavioral performance,” Journal of Theoretical Biology, 256:227-239 (Reed-Elsevier 2009)); alternative models such as nonparametric approaches and neural networks (see, e.g., Reifman, J., “Alternative Methods for Modeling Fatigue and Performance,” Aviation, Space, and Environmental Medicine, 75:No. 3, §II (March 2004)); and/or the like. Particular embodiments of the presently disclosed invention may make use of any one or more of the biomathematical models described in the aforementioned references or various combinations and/or equivalents thereof. All of the publications referred to in this paragraph are hereby incorporated by reference herein.

The presently disclosed invention may utilize one or more of the foregoing biomathematical models to predict neurobehavioral performance levels when certain inputs are provided. Particular embodiments may focus on fatigue and/or alertness as the specific neurobehavioral characteristic being measured and/or assessed.

Method 100 may then proceed to step 104 wherein a sleep prediction model is received at the processor in accordance with particular embodiments. A step-104 received sleep prediction model comprises any set of computational tools that can estimate a person's anticipated sleep schedule (or, conversely, their sleep history if applied retroactively) based upon any one or more inputs including, without limitation, work history, work schedule, activity history, activity schedule, fatigue level, and/or the like. In particular (non-limiting) embodiments, the step-104 received sleep prediction model comprises a set of equations that predicts sleep timing and duration from work and/or activity schedules. In particular (non-limiting) embodiments, the step-104 received sleep prediction model comprises a set of heuristic rules for estimating sleep intervals based upon work and/or activity schedules. Such heuristic rules (or “rules of thumb”) may comprise best estimates of a person's sleep activity based upon observed patterns in either the individual him- or herself or in others similarly situated (e.g., shift workers, over-the-road drivers, pilots and flight attendants, emergency responders, medical professionals, etc.). In particular (non-limiting) embodiments, the step-104 received sleep prediction model may comprise the following exemplary and non-limiting set of heuristic rules:

TABLE 2
Heuristic Rules for Sleep Prediction

| | |
|---|---|
| 1. | An individual will sleep for an eight hour |
| | period ending two hours before their |
| | longest, normal work shift. |
| 2. | An individual will sleep for at least eight |
| | hours of any 16-hour long period of off |
| | duty time. |
| 3. | An individual will sleep within two hours |
| | after having worked for a 16 or more hour |
| | long period. |

In other (non-limiting) embodiments, the sleep prediction model may comprise of an iterative simulation of sleep propensity using bio-mathematical, and set of thresholds to determine when sleep and wake occur.

Regardless of the form in which the step-104 received sleep prediction model takes, applying the step-104 received sleep prediction model to the individual's work and/or activity schedule (or history) will produce an estimated sleep schedule (or history) for that individual. As such, applying the step-104 received sleep prediction model to a work schedule—such, as a trip schedule (which denotes when a driver is working by driving a vehicle)—will give a fairly accurate expectation of when the driver is likely to sleep. Particular (non-limiting) embodiments will make use of this information in the prediction of the driver's fatigue state while driving a particular proposed trip schedule in accordance with the following discussion (see, e.g., step 110 of Method 100; FIG. 1A).

Method 100 may then proceed to optional step 105 wherein an assortment of information relevant to driving a particular trip (so-called “travel data”) may be received at the processor, in accordance with particular embodiments. Optional step-105 received travel data may comprise any information affecting conditions that impact the driver of a particular trip in executing his or her intended travel plans for that trip, including (without limitation) weather conditions, road conditions, traffic conditions, location of construction projects, presence of tolls, weight restrictions on particular roads, law enforcement activity, and/or the like.

Method 100 may continue in step 106 wherein one or more route plans are generated from the step-101 received trip data (or otherwise received from another system, device, method, and/or the like). A route plan generated in step 106, as illustrated in (non-limiting) exemplary data class diagrams of FIGS. 2C and 2D, comprises a route identifier (or name), a start waypoint, an end waypoint, and one or more segments connecting the start way point to the ending waypoint (as illustrated in the case of a “simple” route plan of FIG. 2C, without any intermediate waypoints). Optionally, for those trips with intermediate waypoints, a step-105 generated route plan may also comprise (as illustrated in the case of an “arbitrary” route plan of FIG. 2D) one or more intermediate waypoints and a set of one or more segments connecting each waypoint. Route plans may be generated in step 106, according to particular embodiments, using any of several technologies readily available in the prior art, including (without limitation): mapping software (Google Maps, Mapquest, and/or the like), scheduling software for the transportation industry (here.com, Telogis, Paragon, and/or the like), and/or the like. According to particular embodiments, step-105 generated route plans may be received from other technology systems such as, without limitation, the Internet, embedded systems, and/or the like that incorporate the foregoing readily available technologies.

The multiple views of FIG. 3 illustrate how a single trip may be divided into a set of distinct routes (in this case three routes) wherein each route comprises different sets of route segments. FIGS. 3A, 3B, and 3C each illustrate the same driving trip—namely the trip from 1919 Green Street (start waypoint) to 3401 Market Street (end waypoint) in Philadelphia, Pa., USA—with each figure illustrating a different route for completing the trip. Data and imagery for the figures comes from the popular “get directions” feature of Google Maps, but any method for analyzing trips into one or more routes may be used according to particular embodiments. The following three charts provide details concerning the set of segments that comprise each of the three routes.

TABLE 3
Route of FIG. 3A-3401 Market via Spring Garden Street
Trip Departure Interval: 9:00 AM • Trip Arrival Interval: 9:00-9:30 AM

| | | | Estimated | | Segment | Segment |
|---|---|---|---|---|---|---|
| Segment | Segment Start | Segment End | Segment | Segment | Arrival | Departure |
| Identifier | Location | Location | Travel Time | Distance | Interval | Interval |
| Segment 1 | 1919 Green | 19^{th} & Green | 2 min. | 0.2 mi. | 9:02 | 9:02 |
| Segment 2 | 19^{th} & Green | 19^{th} & Spring | 1 min. | 0.1 mi. | 9:03 | 9:03 |
| | | Garden | | | | |
| Segment 3 | 19^{th} & Spring | 32^{nd} & Spring | 12 min. | 1.2 mi. | 9:15 | 9:15 |
| | Garden | Garden | | | | |
| Segment 4 | 32^{nd} & Spring | 32^{nd} & Market | 3 min. | 0.3 mi. | 9:18 | 9:18 |
| | Garden | | | | | |
| Segment 5 | 32^{nd} & Market | 34^{th} & Market | 1 min. | 0.1 mi. | 9:19 | 9:19 |

TABLE 4
Route of FIG. 3B-3401 Market via 21^{st} Street
Trip Departure Interval: 9:00 AM • Trip Arrival Interval: 9:00-9:30 AM

| | | | Estimated | | Segment | Segment |
|---|---|---|---|---|---|---|
| Segment | Segment Start | Segment End | Segment | Segment | Arrival | Departure |
| Identifier | Location | Location | Travel Time | Distance | Interval | Interval |
| Segment 1 | 1919 Green | 19^{th} & Green | 2 min. | 0.2 mi. | 9:02 | 9:02 |
| Segment 2 | 19^{th} & Green | 19^{th} & Spring | 1 min. | 0.1 mi. | 9:03 | 9:03 |
| | | Garden | | | | |
| Segment 3 | 19^{th} & Spring | 21^{st} & Spring | 12 min. | 1.2 mi. | 9:15 | 9:15 |
| | Garden | Garden | | | | |
| Segment 4 | 21st & Spring | 21^{st} & Market | 3 min. | 0.3 mi. | 9:18 | 9:18 |
| | Garden | | | | | |
| Segment 5 | 21^{st} & Market | 34^{th} & Market | 1 min. | 1 mi. | 9:19 | 9:19 |

TABLE 5
Route of FIG. 3C-3401 Market via JFK Blvd.
Trip Departure Interval: 9:00 AM • Trip Arrival Interval: 9:00-9:30 AM

| | | | Estimated | | Segment | Segment |
|---|---|---|---|---|---|---|
| Segment | Segment Start | Segment End | Segment | Segment | Arrival | Departure |
| Identifier | Location | Location | Travel Time | Distance | Interval | Interval |
| Segment 1 | Green | 19^{th} & Green | 2 min. | 0.2 mi. | 9:02 | 9:02 |
| Segment 2 | 19^{th} & Green | 19^{th} & Spring | 1 min. | 0.1 mi. | 9:03 | 9:03 |
| | | Garden | | | | |
| Segment 3 | 19^{th} & Spring | 21^{st} & Spring | 12 min. | 1.2 mi. | 9:15 | 9:15 |
| | Garden | Garden | | | | |
| Segment 4 | 21st & Spring | 21^{st} & Market | 3 min. | 0.3 mi. | 9:18 | 9:18 |
| | Garden | | | | | |
| Segment 5 | 21^{st} & Market | 34^{th} & | 1 min. | 0.1 mi. | 9:19 | 9:19 |
| | | Market | | | | |

The multiple views of FIG. 3 (i.e., FIGS. 3A, 3B, and 3C) illustrate three distinct routes between the same set of waypoints, as utilized by particular embodiments and as discussed previously in connection with Tables 3, 4, and 5, above. Step 106 of Method 100 generates a plurality of routes connecting the start waypoint and the end waypoint from the step-101 received trip data. Although simple in nature, the multiple views of FIG. 6 illustrate that there are often more than one route between two waypoints.

Method 100 may then proceed to step 108 wherein a trip schedule is determined by combining the step-106 determined route plans and the step-101 received trip data (particularly the trip start and end intervals). The non-limiting exemplary data class diagram of FIG. 2J provides an illustrative framework for how the travel segment times determined in step 107 may be combined with the segment identifiers of a route plan determined in step 106 along with the start and end intervals received as trip data in step 101 to generate a trip schedule. Any means to generate an Hours-of-service compliant trip schedule that also meets all stated business objectives (e.g., on-time delivery, fuel efficiency, driver safety, etc.) may be used by the presently disclosed invention. The generation of such schedules is an active area of research within the prior art—see, e.g., Claudia Archetti and Martin Savelsbergh, “The Trip Scheduling Problem,” 43:4 Transportation Science 417-431 (2009), which is hereby incorporated herein by reference in its entirety.

FIG. 1B provides a flowchart diagram illustrating an exemplary (but non-limiting) method 150 for generating trip schedules in step 108 of method 100 (FIG. 1A), in accordance with particular embodiments. Method 150 may commence in step 151 wherein a step-108 generated trip schedule is initialized at the processor (e.g., a data structure is created, a trip schedule identifier is generated, etc.) and the corresponding trip start interval is noted. The trip start interval will serve as the basis to determine an estimated elapsed trip travel time along with shift, work shift, work day, and work week durations for the driver. An elapsed time counter is set or reset to zero (or some other baseline value) in step 152, and if the step-151 noted trip start interval is other than a fixed time (i.e., an interval with only one value), a specific time within the trip start interval is selected in step 153. In particular embodiments, intervals (including, without limitation, trip start intervals and segment departure intervals) may be divided into a set of discrete times, for selection in step 153 and related steps, by using a time-granulation factor (e.g., 5 mins, 15 mins, 30 mins, 1 hour, etc.) and dividing the time interval accordingly (i.e., with a 5 min. factor, a trip start interval from 8:30 AM to 9:00 AM would be discretized into a set of start times comprising 8:30, 8:35, 8:40, 8:45, 8:50, 8:55, and 9:00, etc.) and each discrete time analyzed iteratively in multiple instances of step 153, according to particular embodiments (not shown). For the sake of simplicity, the following discussion of method 150 will assume that all arrival and departure intervals are single-valued times. For those embodiments in which intervals are provided, method 150 as described in the following discussion may be repeated multiple times for each selected discrete time within the interval. In particular embodiments the time-granulation factor is used to turn all arrival/departure intervals in all routes into a set of discrete times and then analyze separately all permutations of each discrete time for all intervals. Available computational resources would be the only limiting factor to such an approach, but adjustments could be made with the time-granulation factor to cut down on computation time if needed.

Method 150 may then proceed to step 154, wherein the start and end times for the next driving segment in the step-151 initialized trip schedule are determined. (During the first iteration of step 151, the next node will be the first node of the trip schedule initialized in step 151.) The step-154 determined driving segment start and end times may be retrieved from a database, calculated using heuristic rules (e.g., assume a 50 MPH speed); modified to account for daily traffic patterns, time of day, weather conditions, seasonal traffic patterns, and/or the like; or retrieved from another technology system; and/or the like.

The elapsed time counter is then additively updated with an estimated travel time for the driving segment comprising the difference between the step-154 determined driving segment end time and the step-154 determined driving segment start time. In particular embodiments, additional counters (e.g., time since last sleep, length of workday, length of workweek, time or distance since last fuel stop, etc.) (not shown) may be updated as well and used to determine legal and/or regulatory compliance along with other optimization factors (e.g., fuel efficiency, etc.) Method 150 may then proceed to step 156, in which the elapsed time is then checked against the HOS rules (or their equivalent). By way of non-limiting example, if the updated elapsed travel time exceeds 8 hours without at least a 30 min break having already elapsed, this fact is noted in the step-156 rules check. Additionally, if the updated elapsed time counter places the workday in excess of 14 hours, for example, this fact is noted, etc. The elapsed time is compared for compliance with workday and workweek length, break lengths, time since last rest, etc. Based upon the result of this comparison, one or more actions may then be taken in step 157 with respect to the step-151 initialized trip schedule under analysis: a) no stop is scheduled at the next node (because, e.g., no rules are violated by the elapsed time counter when updated in step 155), b) a short wait interval is suggested, c) a longer break (e.g., a 30 required rest, a 2 hour meal or other substantial break, or an 8 to 12 hour rest period) may be inserted, d) a prior step-157 chosen no-stop/wait/break decision from an earlier iteration of method 150 may need to be modified and the subsequent route reassessed, and/or e) the step-151 initialized trip schedule under analysis needs to be discarded (because, e.g., there is no way to comply with the legal and/or regulatory rules or meet the business objectives such as on-time arrival, etc.). In particular embodiments, choice e) may be implemented using a recursive algorithm that tracks back to prior nodes (or segment start/end points) analyzed in prior steps of method 150. The details of a particular recursive algorithm implementing options under choice e) is detailed, below, in connection with the multiple views of FIG. 6 and used in particular embodiments.

Method 150 may then proceed to step 158, wherein diving segment start and end times are updated for all subsequent segments in the step-151 selected trip schedule based upon the outcome of step 157. A check is made in step 159 to determine if estimated end times for each of the driving segments leading to the end waypoint and all time-critical intermediate waypoints are satisfactory for business or other purposes. If not, the route is modified again—e.g., by redirecting method execution flow (shown in dashed lines) back to step 157 to choose another no-stop/wait/break/modify/discard decision in accordance with options a) through e) discussed therewith. If no additional processing in step 157 would make the proposed trip schedule both suitable for business purposes and compliant for legal and/or regulatory purposes, then the trip schedule is discarded, per option e) of step 157.

Method 150 then iterates through all nodes (i.e., all intersections between two route segments) in the step-151 initialized trip schedule and then iterates through each route plan generated or otherwise assigned to the trip under consideration, in step 106 of method 100 (FIG. 1A) as reflected in the nested iterative logic of steps 160 (process all nodes) and 161 (process all route plans), respectively. The set of all route plans processed in method 150 and not discarded therein (in either step 157 or step 159) becomes the set of generated trip schedules, as previously identified, e.g., by step 108 of method 100 (FIG. 1A).

While the foregoing discussion of method 150 of FIG. 1B provides an exemplary method by which trip schedules may be determined from route plans, it is by no means exhaustive. Additional methods may be used and/or slight modifications may be made to method 150 to achieve the same effect. In addition to the basic procedure outlined in method 150, various optimization algorithms may also be incorporated into step 108's generation of trip schedules.

For example, a forward greedy algorithm can be used to find feasible trip schedules that enable drivers to reach destinations within the specified end time window, and may be used to implement the selection logic of step 157 of method 150 (FIG. 1B). The greedy algorithm begins by starting to drive at the earliest possible time as specified by the initial departure window, and driving the maximum allowed duration, or until the destination is reached, whichever is earlier. The greedy algorithm of departing earliest does always need to generate feasible schedules when multiple (or consecutive) destinations are considered as shown in the multiple vies of FIG. 6 (per the discussion below). The greedy forward algorithm can introduce wait times where the driver arrives prior to the opening of the service time window, and the driver is idle but not driving. The wait times are not sufficiently long to be considered rest times, they will affect the future number of hours that can be driven because of hours-of-service regulations. When the algorithm reaches a point where a load is not reached in time, the algorithm can backtrack and identify these wait times and either extend the wait time to a full rest duration, or can delay the departure after any of the prior rest time by extending the rest time beyond the statutory minimum.

The multiple views of FIG. 6 illustrate how the greedy algorithm can be put to use by the presently disclosed invention according to particular (non-limiting) embodiments. FIG. 6A provides a graph of distance (y-axis) versus time (x-axis) for a hypothetical driving trip in simplified form. On the graph of FIG. 6A, a start interval 601, an arrival interval 602 for an intermediate waypoint, and an arrival interval 603 for an end waypoint are identified. As illustrated, the trip must depart from the start waypoint within 5 units of time (hypothetically, hours in this case) and must reach the intermediate waypoint sometime between when 30 and 45 time units have elapsed and must reach the endpoint at any time before 40 time units have elapsed. To commence the greedy algorithm, it will be a starting assumption that the trip leaves as early as possible and that the driver drives for the maximum duration permitted by the step-102 received hours-of-service rules. This is illustrated by trajectory 604 in FIG. 6B, where the driver is able to complete 11 distance units (hypothetically, each unit is, e.g., 50 miles) in 11 time units.

After 11 time units, however, the hours-of-service rules require that the driver take a 10 hour consecutive break before driving. Consequently, for the next 10 time units, no additional progress is made toward either the intermediate or end waypoints. This fact is illustrated by a flat trajectory or “line” 605 in FIG. 6C, indicating that time is elapsing (x-axis) but no distance is being traversed (y-axis). After the required rest and/or sleep period, however, the driver may recommence driving.

FIG. 6D reflects the newly recommenced driving trip reaches the intermediate waypoint via trajectory 606. As illustrated, however, the intermediate waypoint is not reached during the appropriate arrival interval for that waypoint (e.g., the factory or storage facility is not yet open for business, etc.). An inefficiency is therefore introduced, and the driver must wait at the intermediate waypoint until the arrival interval is reached. This fact is illustrated in FIG. 6E by the flat line 607, indicating an additional wait period of approximately 5 time units.

Once whatever scheduled activity is conducted at the intermediate waypoint (e.g., loading, unloading, maintenance, refueling, inspection, etc.), the driving trip may recommence en route to the end waypoint. This fact is illustrated in FIG. 6F by trajectory 608, indicating that another 5 or so distance units are covered in approximately five time units.

Based on the elapsed time of the trip thus far, the hours-of-service rules mandates that the driver take another forced rest stop before continuing, as illustrated by the flat line 609 in FIG. 6G, which shows another rest interval of 10 time units. As such, the driver does not reach the end waypoint during the expected end waypoint arrival interval 603. FIG. 6H shows the driver reaching the end waypoint via travel trajectory 610 after a total of 46 time units have elapsed, which is 11 more time units than was expected and/or permitted.

At this point, the greedy algorithm would detect an inefficiency has occurred and start looking for modifications to the trip schedule in step 157 of method 150 (FIG. 1B) by exercising option d), modify an earlier wait/break determination. The algorithm might, for example, return to the situation occurring when the driver arrives to the location of the intermediate waypoint but at an earlier than expected time (e.g., after travel trajectory 606 of FIG. 6D), such as the case illustrated again in FIG. 6I. Since business constraints require that the truck wait at this intermediate waypoint until the arrival window opens, there is but no choice but to insert another wait period 607 into the trip schedule at this point. FIG. 6J illustrates this fact (in a fashion similar to the prior analysis of FIG. 6E).

During this iteration, however, the algorithm will insert an additional wait period at the intermediate waypoint before continuing the driving trip. FIG. 6K illustrates this fact with wait period 611 (of approximately 5 time units) and a resumed trip trajectory 612, in which an additional 6 distance units are covered in another 5 time units. In this improved scenario, the driver reaches the end waypoint without having to take another forced rest stop after leaving the intermediate waypoint and therefore reaches the end waypoint in only 40 total time units. Unfortunately, this is still not fast enough, since the arrival window at the end waypoint closed 5 time units earlier.

The greedy algorithm then tracks back to the beginning of the planned trip (since no other wait prior wait periods exist) for a fresh analysis of the situation, as illustrated in FIG. 6L, with start interval 601, intermediate waypoint arrival interval 602, and end waypoint arrival interval 603 and no other rest or travel intervals included. For this iteration, the trip does not start until the very end of the departure interval 601, after 5 time units have elapsed, as illustrated in FIG. 6M. At that time, the driver drives for 10 time units (and covers 10 distance units), as shown in travel trajectory 613. Hours-of-service rules mandate a stop at this point, at which time the driver ceases driving for a rest interval of 10 time units. FIG. 6N illustrates this fact with flat line 614, representing a period of no travel. The trip may then recommence, and the driver then reaches the intermediate waypoint 5 time units later as shown in FIG. 6O with travel trajectory 615. Under this scenario, however, the driver reaches the intermediate waypoint during its acceptable arrival interval, and no unnecessary delay is introduced waiting for this time window to open. Furthermore, fresh off a rest imposed by the hours-of-service, there is no need for another scheduled stop. The driver has plenty of eligible time units remaining before another forced rest period.

As such, the trip may proceed with the driver continuing on to the end waypoint, as shown in FIG. 6P via travel trajectory 616, wherein it is illustrated that the final waypoint is reached within its acceptable arrival interval.

This greedy-algorithm approach may be implemented by particular embodiments of the present invention, whether those embodiments utilize the precise method 150 of FIG. 1B or one substantially similar to it. Analysis of trip goals such as on-time arrival to designated waypoints may be conducted within step 159 of method 150 or of any related step of a similar method. Inserting rest and/or wait intervals and/or revisiting earlier rest and/or wait intervals may be accomplished by step 157 of method 150 or of any related step of a similar method. In particular (non-limiting) embodiments, the greedy algorithm thus described may be implemented using a recursive algorithm that traverses a tree or tree-like data structure where each leaf or node on the tree represents a node in the driving trip (i.e., the intersection between two route segments and/or wait intervals).

For those embodiments in which an uncertainty value for specific driving segment start and/or end times was calculated in step 107, it may be possible to tabulate an uncertainty value associated with the trip schedule as part of step 108. In particular embodiments, this may involve little more than summing the particular uncertainty values (when, e.g., the uncertainty values comprise existing time ranges). In other embodiments, the standard rules regarding error propagation may come into play—e.g., when the uncertainty value associated with a segment travel time is expressed as a percentage of the segment travel time, etc.

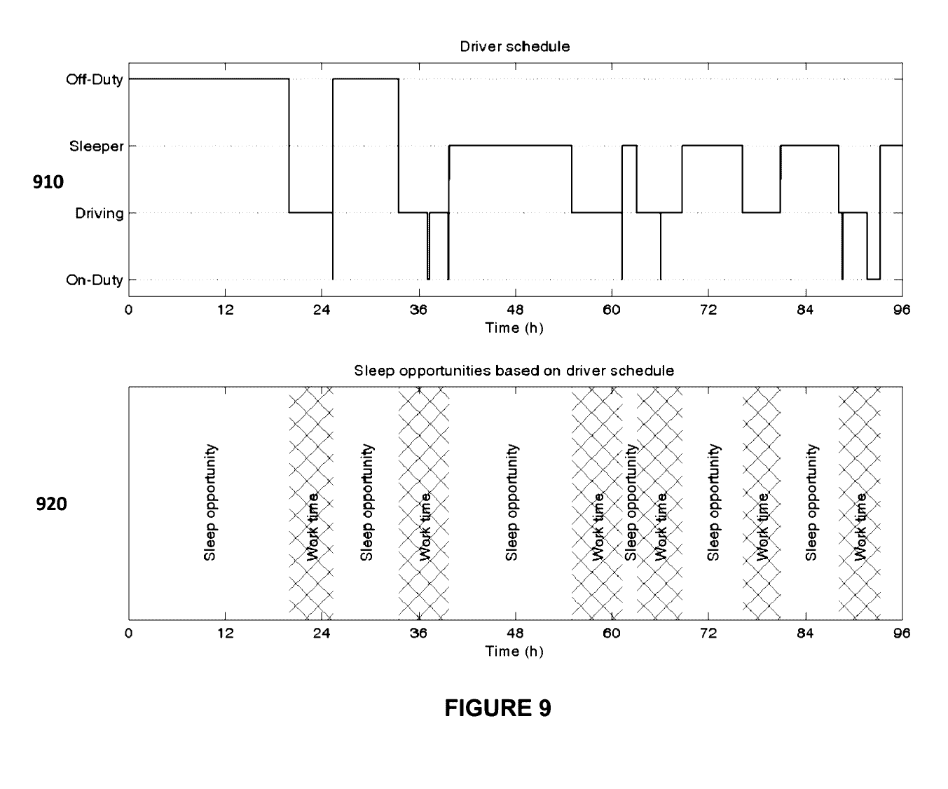

Returning attention back to method 100, after trip schedules are generated in accordance with the foregoing discussion in step 108, method 100 may then proceed to step 109 wherein one or more sleep schedules for a driver are determined from the step-108 generated trip schedules, in accordance with particular embodiments. In particular (non-limiting) embodiments, the step-104 received sleep prediction model is applied to the step-108 generated trip schedules to yield the step-109 determined drivers sleep schedules. In such cases, a driving schedule (comprising just the times the driver is actually driving) may be gleaned from the step-108 generated trip schedule by paying attention only to those periods of time in which the driver is engaged in driving activities as determined by the driving segment start and end times. FIG. 9 illustrates (in a non-limiting fashion) how a step-109 determined driver sleep schedule may be determined from a step-108 generated trip schedule; specifically graph 910 provides a timeline of the different activities a specific driver will be expected to be conducting during a 96 hour period in which a specific driving trip is being performed. The driver's activities may be divided into four categories-off duty, off-duty and in the sleeper compartment of a sleeper cab, on-duty but not driving (e.g., paperwork, maintenance, refueling, dock work, etc.), and on-duty while driving. According to the trip schedule illustrated, the driver will be off duty for the first 20 hours, driving for the next 5 hours, off duty for the following 7 hours, driving for 2 hours, then on-duty but not driving for a short period of time (less than one hour), at which time he resumes driving for approximately an hour, then heads into the sleeper compartment for approximately 16 hours, and so forth as illustrated in Graph 910. Graph 920 illustrates how this activity schedule can be analyzed for sleep opportunities. For the illustrated situation, one of the simpler cases, sleep opportunities are identified when the driver is off duty or in the sleeper berth. A driver may or may not sleep even when given a sleep opportunity, and the sleep prediction model is further used to predict when sleep occurs within the sleep opportunities. These are inferences that correspond to rules or equations contained within the step-104 received sleep prediction model.

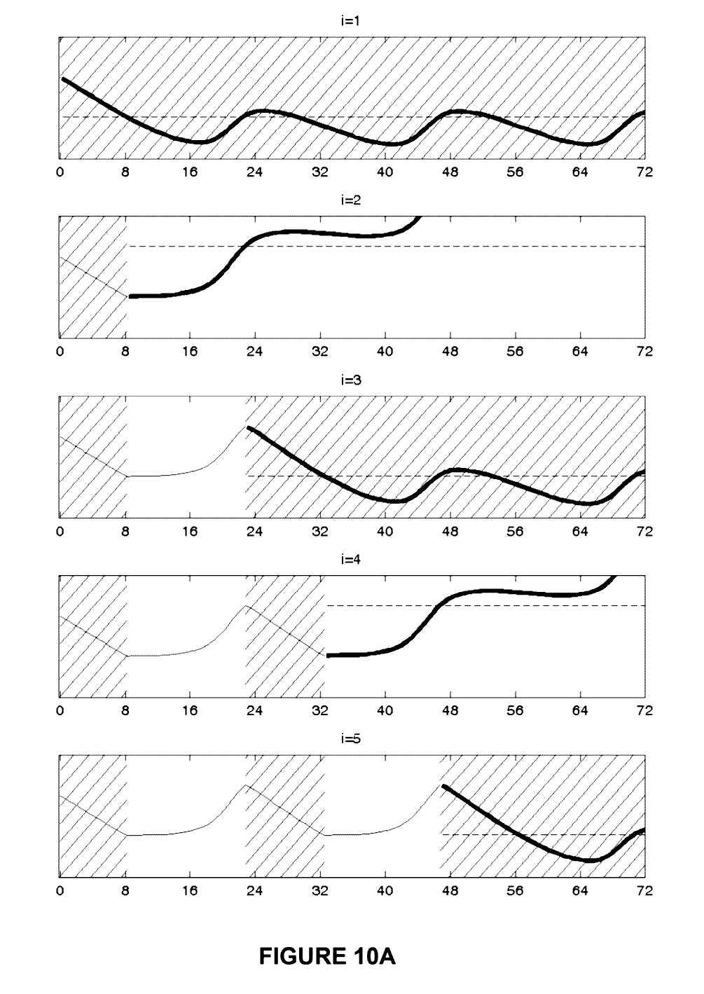

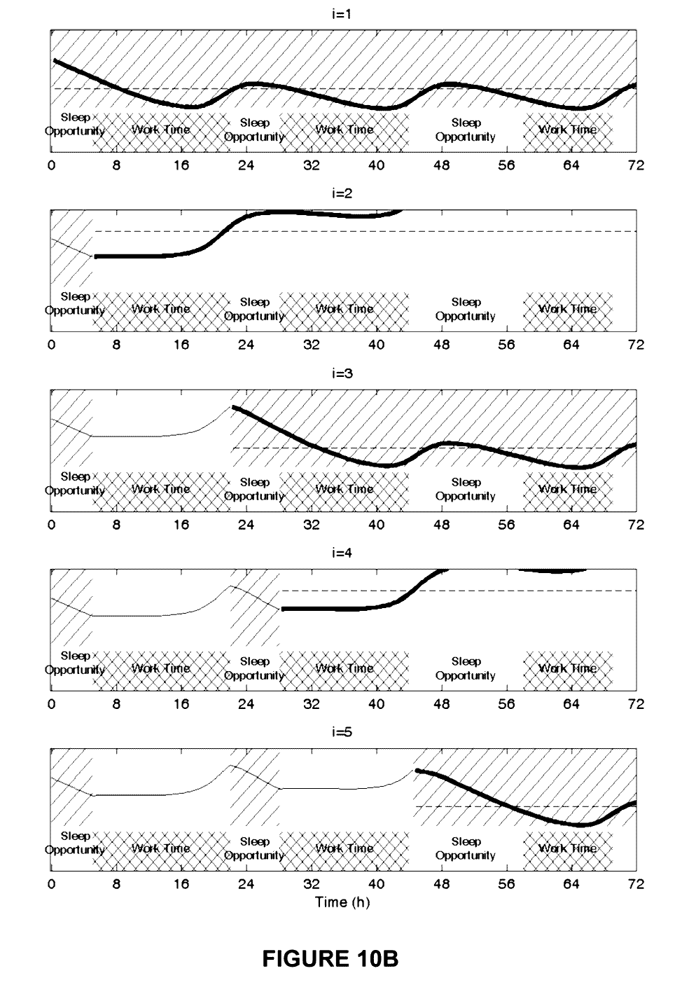

FIGS. 10A and 10B shows the sleep prediction for two different schedules based on one embodiment of the sleep prediction model that uses an iterative forward simulation. Given the sleep opportunities, the sleep prediction assumes sleep (or wake depending on availability to sleep) from the beginning of the proposed schedule through the end of the proposed schedule. A sleep homeostasis model is used to simulate the sleep propensity shown in FIG. 10A iteration i=1. In this example, 10A, there are no work constraints, and sleep continues until sleep propensity falls below a set threshold (indicated by the dotted line), at which point wake is assumed going forward (iteration i=2), and the sleep homeostasis model is used to simulate the sleep propensity. Again, with no work constraints, wake continues until the sleep propensity exceeds a threshold (indicated by the dotted line), at which point sleep begins again (iteration i=3). This process is repeated (as in iteration i=4, and i=5) until the end of the schedule period.

FIG. 10B shows an example of the sleep prediction for a schedule which includes work constraints. Similar to 10A, a sleep homeostasis model is used to predict sleep propensity, and a forward simulation is used in an iterative fashion to determine sleep and wake. However given work constraints and sleep and wake timing is determined by sleep propensity, but sleep may be delayed or cut short depending on when work occurs. For example, iteration i=3, the sleep propensity does not fall below threshold until 32 h, however a work period at 30 h, cuts the sleep short at that time.

According to particular embodiments, another method for estimating sleep using a sleep can be used based on classification models and machine learning. A classification algorithm, such as a restricted Boltzmann machine is trained using sleep and Hours-of-service data of driver.

Method 100 may then proceed to step 110 wherein one or more fatigue levels may be determined for the driver at one or more times during the one or more step-108 generated trip schedules, in accordance with particular embodiments. In particular (non-limiting) embodiments, step-110 determined fatigue levels are determined by applying the step-103 received neurobehavioral performance model to the step-109 determined driver sleep schedule. In particular (non-limiting) embodiments, step-109 determined fatigue levels are determined for a particular time granularity level (e.g., every 10 mins, every hour, etc.) for the entire duration of a driving trip. In particular (non-limiting) embodiments, a fatigue level is determined as a time series function (e.g., F=f(t), where F is fatigue, and f(t) is a mathematical function of time, expressed either analytically or strictly computationally, and/or the like).

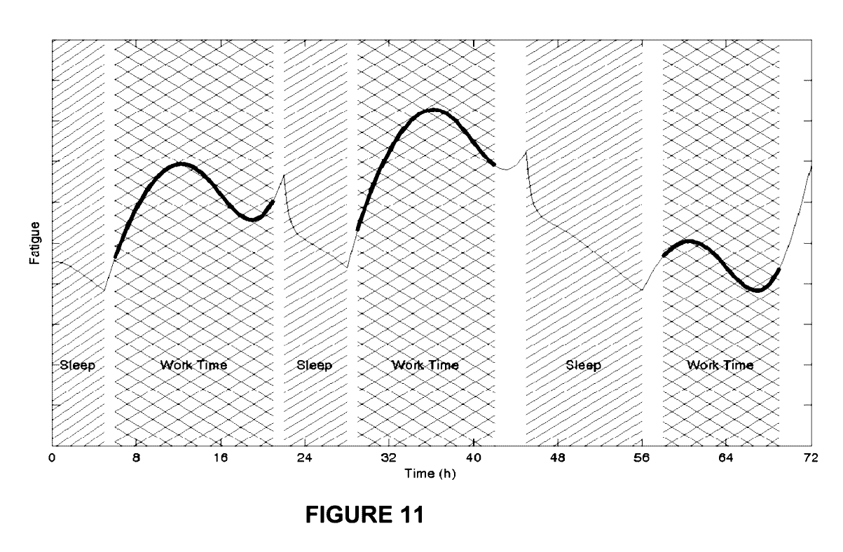

FIG. 11 illustrates the fatigue levels predicted in step 110 for a driver from a trip schedule, given the predicted sleep as the outcome of step 109 of method 100. A bio-mathematical model of fatigue (such as McCauley et. al) that accepts sleep as input is used to predict the fatigue levels at all the driver's wake times. The periods demarked by cross-hatches are work periods as determined by the proposed work schedule, and the periods demarked with hatched lines represent the periods where sleep is predicted from the schedule. The fatigue is then predicted over the entire interval by simulating the fatigue model for the entire schedule period given the sleep and wake intervals. Method 100 may then proceed to optional step 111 wherein a score is determined for each trip schedule, according to particular embodiments. Optional step-111 determined scores may comprise any metric useful for comparing one or more step-108 trip schedules to one another. Optional step-111 calculated scores may comprise a numerical metric, a rating (Hi, Medium, Low; Good, Bad; and/or the like), a categorization (generic categories A, B, C, etc.; safe, unsafe; profitable, unprofitable; and/or the like), or any other means by which a comparison may be expressed. Optional step-111 calculated scores may take into account, as inputs, (without limitation) the step-110 determined driver fatigue levels, the step-102 received hours-of-service rules, and/or the step-108 determined trip schedules (including any of its critical data components, such as, without limitation, the anticipated arrival interval, any one or more of the trip segments, and/or the like). In particular (non-limiting) embodiments, optional step-105 received trip data may also be included as an input to the optional step-111 calculated trip-schedule score.

In the case that the optional step-Ill calculated score is determined at least in part by the driver fatigue levels determined in step 110, the fatigue associated with the trip schedule is based in part on the fatigue during the driving segments, and, if any, the on-duty segments as well. The fatigue prediction over the trip schedule can reduced to a single number based on including but not limited to the average fatigue while driving, the maximum fatigue while driving, and the number of hours driving over a set fatigue threshold. In particular embodiments, this fatigue prediction over the trip may comprise the step-111 calculated score.

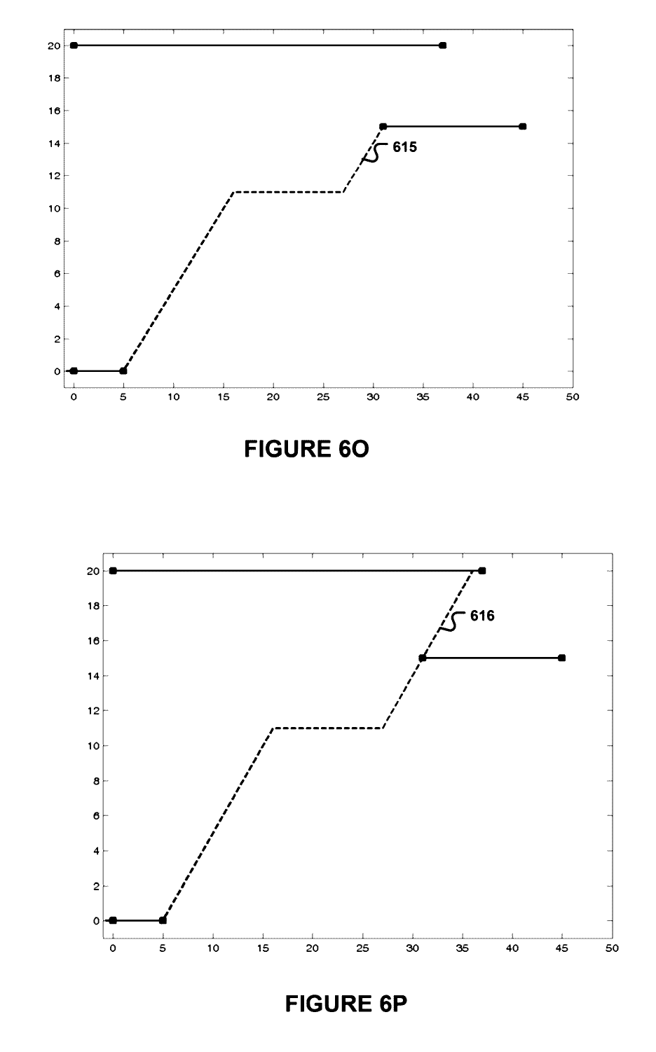

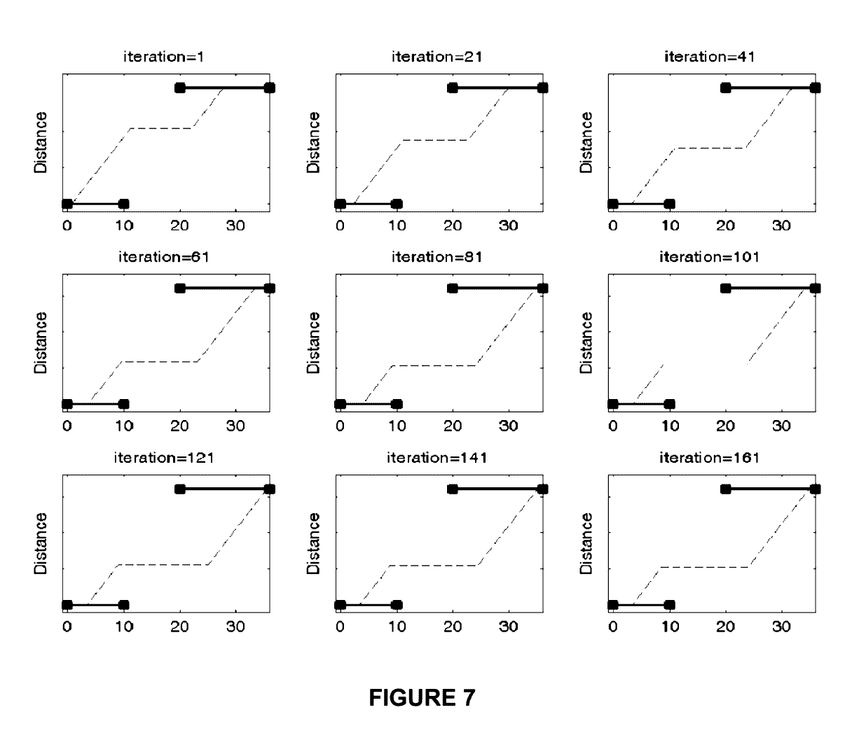

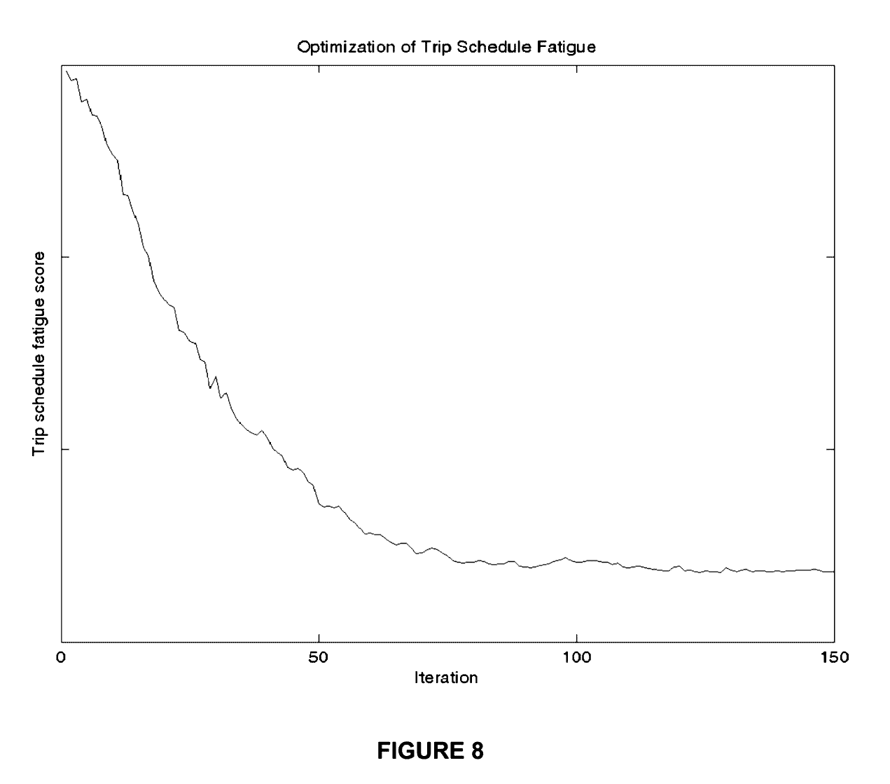

Method 100 may then enter into optional steps 112 and 113, wherein steps 106 through 111 are repeated a plurality of times so as to create a plurality of step-111 calculated trip-schedule scores, and, in step 113, a particular step-108 generated trip schedule is selected based upon its step-111 calculated score. Basis for selection may include (without limitation) highest or lowest score, best or worst classified score, and/or the like. The greedy algorithm can be used to find one trip schedule that satisfies the trip, and can be used as a starting point to generate alternate plans that can be evaluated as part of an optimization procedure. The start time, drive durations, rest/break durations, and number of overall breaks/rests can be varied, in so far that the modification do not violate Hours-of-service regulations and delivery and pickup times are satisfied. FIG. 7 illustrates an optimization of the trip schedule on simulated annealing, that randomly varying the start times, drive durations, and rest durations to generate different scenarios for a trip between a start waypoint and an end waypoint. At each iteration, the new trip schedule is scored and is accepted if the score is better than the previous trip schedule, and accepted stochastically if it does not improve the previous trip schedule. Accepting trip schedules that do not improve the overall trip schedule score prevents the optimization procedure from being trapped in a local minimum (or maximum), and find the trip schedule with the global minimum (maximum). FIG. 7 shows different solutions found after iterations 1, 21, 41, 61, 81, 101, 121, 141, and 161 of the algorithm. The optimization algorithm generates trip schedules that progressively improve as shown in FIG. 8. FIG. 8 provides a graph of a particular optimization variable (y-axis), in this case a fatigue score—discussed below in connecting with step 111 of method 100 (FIG. 1A) and in connection with the multiple views of FIG. 10—plotted against the iteration number i of the algorithm.

Method 100 may then enter into optional steps 114 and 115, wherein the step-108 generated trip schedule is modified in one or more ways, in accordance with particular embodiments. Modification of the step-108 generated trip schedule in optional step 114 may comprise (without limitation): the insertion of a rest interval between driving two segments, delaying a start time from one or more segments, making adjustments for slower-than-expected segment travel times, and/or the like. 6. According to particular embodiments, modifying the determined trip schedule comprises one or more of: advancing or delaying a start time or end time of the trip schedule or a driving segment thereof; inserting or removing an off-duty segment, on-duty segment, and/or sleeper segment into the trip schedule; and/or advancing or delaying a start time or an end time of an off-duty segment, an on-duty segment, and/or a sleeper segment in the trip schedule. Off-duty segments are periods of time between step-154 determined driving segments in which the driver must go off duty (and not drive) to comply with Hours-of-service rules. On-duty segments are periods of time between step-154 determined driving segments in which the driver remains on duty but performs work-related tasks other than driving (e.g., vehicle maintenance and inspection, administrative paperwork, refueling, loading and unloading freight, etc.). Sleeper segments are periods of time between step-154 determined driving segments in which the driver is assigned to the sleeper compartment of a sleeper-compartment enabled vehicle while another driver drives the vehicle.

Upon modifying a trip schedule in step 114, optional step 115 compares the step-114 modified trip schedule with the step-108 generated trip schedule and/or the step-113 selected trip schedule so as to locate a suitable candidate among them for provision to a driver or other personnel in the next method step.

In particular (non-limiting) embodiments, comparison step 115 requires that the step-114 modified trip schedule be subjected to the same prerequisite steps needed for scoring as in step 111. This may include (without limitation) estimating new segment travel times (similar to step 107), generating a trip schedule (similar to step 108), determining a driver sleep schedule (similar to step 109), determining fatigue levels (similar to step 110), and calculating a score for the trip schedule (similar to step 111). In particular (non-limiting) embodiments, the aforementioned prerequisite steps are identical to steps 107 through 111, and in other embodiments, modifications and/or shortcuts may be made since the target sleep schedule has already been processed accordingly (e.g., in some cases only partial recalculation of segment travel times, driver sleep schedules, fatigue levels, or trip-schedule scores may be required, and/or the like).

Step 115 comparison of the step-114 modified trip schedule and either the step-113 selected trip schedule or the step-108 generated trip schedule may comprise any form of comparison, such as (without limitation) comparison based strictly on step-111 calculated trip-schedule score (or its equivalent in the case of a step-114 modified trip schedule), based strictly on step-109 determined drive fatigue level (or its equivalent in the case of a step-114 modified trip schedule), based strictly on an expected arrival time, or based upon any of the foregoing, and/or the like.

Method 100 may then enter step 1116 in which case a human driver or other suitable personnel (e.g., an administrative user, a business manager, a government regulator and/or the like) is provided with a trip schedule and accompanying score, according to particular embodiments. The step-116 driver-provided trip schedule and score may comprise the output of the step-115 comparison of trip schedules, of the step-114 modification of trip schedules, the step-113 selection of trip schedules, or of the step-108 generation of trip schedules per the various embodiments and accompanying logic as explained in the foregoing discussion. The driver may be provided the trip schedule in any useable form and via any useful medium—including (without limitation) in electronic or hard copy formats, transmitted across one or more computer networks (including, without limitation, an extranet, internet, and/or the Internet), provided in electronic format as part of hardware assigned to the driver whether attached to or embedded in a vehicle or not (e.g., transmitted to a GPS device attached or associated with a particular truck; included as a data file on a PDA or laptop assigned to the driver; transmitted to an embedded navigation system on a vehicle; and/or the like). From step 116, the driver will be able to discern the selected route, the estimated trip schedule, and the identified score from the foregoing algorithm. Accordingly, the driver may then choose to drive the route according to the route schedule provided in step 116.

Method 100 may then proceed to optional step 117 wherein the trip schedule may updated with real-time information based upon a driver's actual progress in driving a trip in accordance with the step-116 provided trip schedule, according to particular embodiments. In particular (non-limiting) embodiments, step 117 may proceed in accordance with method 120 provided in FIG. 1C. For method 120, location data including a time stamp is received at the processor in step 121, wherein location data comprises any information capable of describing the location of the vehicle at a particular time, and the time stamp provides the time at which the vehicle is or was at the provided location. Method 120 may then proceed to step 122 wherein a variance is determined as between the vehicle's location at the step-121 received time stamp and its anticipated location according to the step-116 provided trip schedule. A step 122 comparison may be performed by using the step-121 received location data to identify on which travel segment the vehicle should be located based on the step-116 provided trip schedule by consulting the travel start and end times. If the vehicle's actual location is on the identified travel segment (or, conversely, not progressed far enough along the travel segment—in those cases of long travel segments such as are used during interstate travel), a variance may be determined in step 122. The variance identifies how far behind schedule the vehicle may be. In step 123 the step-122 determined variance is compared to a threshold to determine whether the trip schedule needs to be recalculated. If so, the location data and time stamp received in step 121 become a new start waypoint and start time and process flow is sent back to step 106 for new route plans to be determined, etc. If not, process flow is sent to step 118 instead without modification to the trip schedule.

Method 100 may then enter optional step 118 wherein driver preferences may be determined. Step-118 determined driver preferences comprise any characteristic of how an assigned trip schedule was executed (i.e., driven) by a particular driver that might tend to show deviations from the step-116 provided trip schedule. Non-limiting examples of step-118 determined driver preferences include preferred roads, preferred rest-stop waystations, preferred travel times, preferred travel speeds (e.g., indication of speeding, etc.). Once driver preferences are determined, future trip schedules that are provided to the driver can be tailored to incorporate as many of the preferences as possible.

Certain implementations of the invention comprise computer processors which execute software instructions which cause the processors to perform a method of the invention. For example, one or more processors may implement data processing steps in the methods described herein by executing software instructions retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. For example, data may be delivered over a network, such as a local-area-network, wide-area-network, or the internet, to a different computational device that scores the response times. Such a system may enable a distributed team of operational planners and monitored individuals to utilize the information provided by the invention. Such a system would advantageously minimize the need for local computational devices.

Certain implementations of the invention may comprise exclusive access to the information by the individual subjects. Other implementations may comprise shared information between the subject's employer, commander, flight surgeon, scheduler, or other supervisor or associate, by government, industry, private organization, etc., or any other individual given permitted access. Certain implementations of the invention may comprise the disclosed systems and methods incorporated as part of a larger system to support rostering, monitoring, diagnosis, epidemiological analysis, selecting or otherwise influencing individuals and/or their environments. Information may be transmitted to human users or to other computer-based systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

It will be apparent to those skilled in the art in the light of the foregoing disclosure, many alterations and modifications are possible in the practice of this invention without departing from the spirit or scope thereof. For example:

The term “result” or “test result” are used in this application to apply generally to any output of a test, whether referring to a specific user response to a question or stimulus, or whether referring to a statistical analysis or other cumulative processing of a plurality of such user responses. In the case of stimulus-response tests, these terms may refer to the time intervals associated with specific responses to stimuli or to a cumulative metric of such time intervals collected in response to a plurality of stimuli presented throughout a test or portion thereof.

Purely analytical examples or algebraic solutions should be understood to be included.

Accordingly it is intended that the appended claims and any claims hereafter introduced are interpreted to include all such modifications, permutations, additions, and sub-combinations as are within their broadest possible interpretation.

What is claimed is:

1. A method for providing a driver with a fatigue-risk scored driving trip schedule, the method comprising:
receiving, at the processor, trip data comprising at least in part a start waypoint, a start time interval, an end waypoint, and an end time interval, the start and end waypoints each comprising at least a geographic location;
receiving, at the processor, one or more driver hours-of-service rules, wherein the driver hours-of-service rules represent one or more constraints on a schedule of driving activities;
receiving, at the processor, a sleep prediction model, the sleep prediction model comprised to determine a sleep schedule for a driver based at least in part upon a schedule of driving activities;
receiving, at the processor, a fatigue prediction model, the fatigue prediction model comprised to determine one or more fatigue levels associated with a driver based at least in part upon a sleep schedule for the driver;
generating, with the processor, one or more route plans based at least in part on the received trip data, each route plan comprising one or more route segments, each route segment comprising at least in part a route segment start location and a route segment end location, wherein the one or more route segments comprise a path, at least, connecting the start waypoint to the end waypoint;
generating, with the processor, one or more trip schedules for each generated route plan, each trip schedule comprising at least in part one or more driving segments, each driving segment corresponding to a driving activity and comprising a driving segment start time and a driving segment end time, and wherein generating the trip schedule comprises, at least in part:
creating a driving segment corresponding to each route segment in a generated route plan, and
estimating the driving segment start time and the driving segment end time for each driving segment;
determining, with the processor, one or more driver sleep schedules by applying the received sleep prediction model, at least in part, to the schedule of driving activities specified in a generated trip schedule;
determining, with the processor, one or more fatigue levels associated with at least one generated trip schedule, wherein the fatigue levels are based upon applying the received fatigue prediction model to at least one of the one or more determined sleep schedules determined from the at least one generated trip schedule; and
providing at least one determined trip schedule and at least one determined fatigue level to one or more of: a driver, an administrative user, a business manager, and a government regulator.

2. The method of claim 1 further comprising:
calculating, with the processor, one or more scores for the determined trip schedule based upon the one or more determined fatigue levels and the received driver hours-of-service rules;
wherein providing at least one determined trip schedule and at least one determined fatigue level to one or more of: a driver, an administrative user, a business manager, and a government regulator, further comprises: proving at least one determined trip schedule, at least one determined fatigue level, and at least one calculated score to one or more of: a driver, an administrative user, a business manager, and a government regulator.

3. The method of claim 2 further comprising:
determining, with the processor, plurality of scores for a plurality of route schedules by repeating, for a plurality of iterations, the steps of:
generating a route plan based at least in part on the received trip data,
generating one or more trip schedules for the generated route plan,
determining a driver sleep schedule based at least in part on the generated trip schedule,
determining one or more fatigue levels, and
calculating a score for the route schedule based upon the one or more determined fatigue levels and the received driver hours-of-service rules; and
selecting a route schedule from the plurality of scored route schedules based at least in part upon a score from within the plurality of determined scores.

4. The method of claim 1 wherein generating one or more trip schedules further comprises:
creating, for each trip schedule, one or more of: one or more off-duty segments, one or more on-duty segments, and one or more sleeper segments;
wherein each off-duty segment comprises an off-duty segment start time and an off-duty segment end time, signifying a time interval wherein the driver is not on working duty and not driving;
wherein each on-duty segment comprises an on-duty segment start time and an on-duty segment end time, signifying a time interval wherein the driver is on working duty but not driving; and
wherein each sleeper segment comprises a sleeper segment start time and a sleeper segment end time, signifying a time interval wherein the driver is in the sleeper compartment of a vehicle being driven by another driver.

5. The method of claim 4 further comprising:
modifying, with the processor, the determined trip schedule;
calculating, with the processor, a score for the modified trip schedule based upon the one or more determined fatigue levels and the received driver hours-of-service rules; and
selecting a trip schedule based at least in part upon a comparison of the calculated score for the determined trip schedule and the calculated score for the modified trip schedule.

6. The method of claim 5 wherein modifying the determined trip schedule comprises one or more of:
advancing a start time of the trip schedule;
delaying a start time of the trip schedule;
advancing a start time of at least one driving segment within the trip schedule;
delaying a start time of at least one trip segment within the trip schedule;
inserting one or more off-duty segments into the trip schedule;
removing one or more off-duty segments from the trip schedule;
advancing a start time of at least one off-duty segment within the trip schedule;
delaying a start time of at least one off-duty segment within the trip schedule;
inserting one or more on-duty segments into the trip schedule;
removing one or more on-duty segments from the trip schedule;
advancing a start time of at least one on-duty segment within the trip schedule;
delaying a start time of at least one on-duty segment within the trip schedule;
inserting one or more sleeper segments into the trip schedule;
removing one or more sleeper segments from the schedule
advancing a start time of at least one sleeper segment within the trip schedule; and
delaying a start time of at least one sleeper segment within the trip schedule.

7. The method of claim 1 wherein estimating the driving segment start and end times is based at least in part upon an estimated travel speed for the corresponding route segment and a distance of the corresponding route segment.

8. The method according to claim 1 further comprising:
receiving, at the processor, travel data, the travel data comprising information as to the speed of traffic flow on one or more segments within the trip, and
wherein estimating, with the processor, a segment travel time for each trip segment of the generated route plan, is based at least in part upon an estimated travel speed for the trip segment, a distance of the trip segment, and the received travel data.

9. The method according to claim 3030 wherein the received travel data comprises one or more of: traffic volume, real-time traffic speed, accident information for a segment, and weather information.

10. The method according to claim 1 further comprising:
receiving, at the processor, location data about a vehicle, the location data comprising a geographic location of the vehicle and a time stamp value;
comparing the location data with the provided trip schedule to determine a degree of variance from the provided trip schedule; and
if the determined degree of variance from the provided trip schedule exceeds a threshold:
assigning, with the processor, the received time stamp value as a new trip start time interval and the received geographic location as a new trip start waypoint;
generating, with the processor, a route plan based at least in part on the received geographic location, the received time stamp value, the end waypoint and the end time interval, the route plan comprising one or more trip segments comprising a route from the received geographic location to the end waypoint; and
repeating the steps of:
generating one or more trip schedules for the generated route plan;
determining a driver sleep schedule based at least in part on the generated trip schedule;
determining one or more fatigue levels; and
providing at least one determined trip schedule and at least one determined fatigue level to one or more of: a driver, an administrative user, a business manager, and a government regulator.

11. The method of claim 1 further comprising:
receiving, at the processor, an actual trip record comprising the route segments actually driven during a driving trip along with corresponding driving segment start and end times for each route segment;
comparing, with the processor, the received actual trip plan with the provided trip schedule to determine a degree of variance between the received actual trip record and the provided trip schedule;
analyzing, with the processor, the determined degree of variance between the trip plans for the existence of driver preferences.

12. The method of claim 1:
wherein estimating a driving segment start time and a driving segment end time for each trip driving segment corresponding to the route segments of the generated route plan further comprises estimating an uncertainty value associated with one or more of a driving segment start and a driving segment end time for at least one driving segment of the generated trip schedule, the uncertainty value representing possible variance in a time of travel for the driving segment;
wherein generating a trip schedule for the generated route plan further comprises calculating an accumulated uncertainty value for each driving segment, the accumulated uncertainty representing the cumulative effect of the uncertainty values associated with all prior driving segments; and
wherein providing at least one determined trip schedule and at least one determined fatigue level to one or more of: a driver, an administrative user, a business manager, and a government regulator, further comprises: proving at least one determined trip schedule, at least one determined fatigue level, and the calculated accumulated uncertainty value for at least one driving segment to one or more of: a driver, an administrative user, a business manager, and a government regulator.

13. A method according to claim 1:
wherein receiving trip data further comprises receiving one or more intermediate waypoints, wherein each intermediate waypoint comprises a geographic destination included within the driving trip; and
wherein generating, with the processor, a route plan based at least in part on the received trip data comprises generating a route plan comprising one or more route segments wherein the one or more route segments comprise a route, at least, from the start waypoint to the end waypoint and including the one or more received intermediate waypoints.

14. A method according to claim 1:
wherein receiving trip data further comprises receiving one or more corresponding intermediate arrival time intervals and one or more intermediate departure time intervals;
wherein each intermediate arrival time interval comprises a time window in which to arrive at the corresponding intermediate waypoint; and
wherein each intermediate departure time interval comprises a time window by which to depart the corresponding intermediate waypoint.

15. A method according to claim 13, wherein receiving trip data further comprises: receiving one or more waypoint type indicators for one or more of the start waypoint, the end waypoint, or one or more of the intermediate waypoints, each waypoint type indicator providing information as to the waypoint.

16. A method according to claim 13, wherein at least one of the one or more received waypoint type indicators comprise one or more of: a service station, a rest stop, a trucking terminal, a fueling station, a customer location, a weighing station, a loading dock, an unloading dock, and a repair facility.

17. A method according to claim 15, wherein receiving trip data further comprises receiving a service time for at least one of: the start waypoint, the end waypoint, and one or more of the intermediate waypoints; the service time indicating a duration of time needed to accomplish one or more required tasks at the corresponding waypoint.

18. A method according to claim 13, wherein the one or more required tasks comprise one or more of: unloading cargo, loading cargo, inspecting cargo, refueling a vehicle, servicing a vehicle, inspecting a vehicle, rest for a driver, changing drivers, conferring with a shipping client, conferring with managerial staff of a transportation interest, and conferring with government or regulatory officials.

19. A method according to claim 1, further comprising:
receiving, at a computer, optimization data indicating one or more operational constraints related to the driving trip by which the driving route will be optimized.

20. A method according to claim 19 wherein the received optimization data comprises one or more of: fuel costs, toll costs, fatigue, probability of on-time pickup and delivery, probability of finding parking spots when arriving at truck stop.

21. A method according to claim 20 wherein the received optimization data comprises one or more of: a set of weighting criteria and a weighting function, and
wherein selecting one or more optimal route plans from the one or more selected compliant route plans comprises applying the one or more of: a set of weighting criteria or a weighting function to the one or more of: fuel costs, toll costs, fatigue, probability of on-time pickup and delivery, probability of finding parking spots when arriving at truck stop.

22. A method according to claim 1 wherein generating one or more route plans comprises receiving route plans from one or more of: mapping software, a mapping system, and a database of route plans.
